(19) United States
(12) Patent Application Publication
(10) Pub. No.: US 2024/0374464 A1
(43) Pub. Date: Nov. 14, 2024

(54) MASSAGE DEVICE FOR PROVIDING MASSAGE FOR BLOOD PRESSURE AND METHOD FOR OPERATING MASSAGE DEVICE

(71) Applicant: BODYFRIEND CO., LTD., Seoul (KR)

(72) Inventors: Soo Hyun CHO, Seoul (KR); Hayejin KIM, Seoul (KR); Sun Mi HEO, Seoul (KR); A Ran MIN, Seoul (KR); Yu Jin JEON, Seoul (KR)

(21) Appl. No.: 18/291,499

(22) PCT Filed: Aug. 31, 2022
(86) PCT No.: PCT/KR2022/012990

§ 371 Date: Jan. 23, 2024

(30) Foreign Application Priority Data
Sep. 10, 2021 (KR) 10-2021-0121131
Dec. 30, 2021 (KR) 10-2021-0193383

(51) Int. Cl. A61H 15/00; A61H 7/00; A61H 9/00; A61H 23/00; A61H 39/04

(52) U.S. Cl. CPC A61H 15/0078; A61H 7/007; A61H 23/006; A61H 39/04; A61H 9/0078; A61H 2015/005; A61H 2201/1676; A61H 2201/5043; A61H 2201/5048; A61H 2203/0431; A61H 2205/04; A61H 2205/062; A61H 2205/088; A61H 2205/106; A61H 2205/12; A61H 2230/305

(57) ABSTRACT

The present disclosure relates to a method for operating a massage device including a blood pressure measuring unit, the method including the steps of: receiving, from a current user, an input indicating that a massage mode for managing blood pressure is to be executed; measuring the blood pressure of the current user using the blood pressure measuring unit; inclining backward a body massage unit included in the massage device; controlling, to a first distance, the distance between a left massage ball and a right massage ball included in a massage module; determining the position of the shoulders of the current user while moving the massage module from the top to the bottom of the body massage unit; providing a massage to the current user using the massage module; and while providing the massage to the current user, outputting a guide signal for inducing breathing of a specific cycle to the current user.

### TECHNICAL FIELD

The present disclosure relates to a massage device for providing a massage for blood pressure. More specifically, the massage device according to the present disclosure provides a massage which can alleviate a user's hypertension.

### BACKGROUND ART

Massage is a medical assistance therapy for controlling a user's physical modulation, helping blood circulation, and relieving fatigue of the user by applying various types of mechanical stimulation to a portion of the body, such as massaging, pressing, pulling, tapping, or moving a portion of the body of the user.

The growth in a massage demand caused an increase in demand for massage devices or massage devices, which provide an artificial massage function, because of economic feasibility and temporal reasons. That is, as the demand for relieving fatigue or stress is increased while loosening the agglomerated muscles through massage, various mechanical massage devices for time and cost efficiencies are being released. A massage device refers to any form of tools, devices, or apparatuses which perform a massage through a mechanical device without a masseur.

Recently, there is an increase in interest in health of people, and the massage device is changing as an electronic device providing various additional functions, and/or medical functions from a device simply providing a massage function. Accordingly, researches on how to efficiently control a massage device are continued.

For example, massage devices capable of measuring a user's blood pressure are being provided recently. However, there are cases in which the user's blood pressure is not accurately measured due to the vibration of the massage device or the posture of the user sitting in the massage device. More specifically, the massage device includes a massage module or air cells to provide a massage to the user. Furthermore, the massage device provides a massage to the user by moving the massage module or inflating the air cells. In this instance, the movement of the massage module and air cells may cause the user's blood pressure to be larger or higher than normal. Accordingly, there is a demand for a massage device which can accurately measure a user's blood pressure.

Korean Patent No. 10-1189364 provides a massage device and a method for controlling the massage device.

### DISCLOSURE

### Technical Problem

Accordingly, the present disclosure has been made in view of the above-mentioned problems occurring in the related art, and it is an objective of the present disclosure to provide a massage device for managing blood pressure and to provide a method for controlling the massage device.

However, objectives of the present disclosure are not limited to the aforementioned objective, and the present disclosure can have other objectives.

### Technical Solution

To accomplish the above-mentioned objects, according to the present disclosure, there is provided a method for operating a massage device, which includes a blood pressure measuring unit. The method for operating the massage device includes: a step of receiving an input from a current user to execute a massage mode for managing blood pressure; a step of determining the position of the current user's shoulders; a step of tilting a body massage unit included in the massage device backward; a step of measuring the current user's blood pressure by using a blood pressure measuring unit; a step of controlling a distance between a left massage ball and a right massage ball included in a massage module to a first distance; a step of providing a massage to the current user by using the massage module; and a step of outputting a guide signal to induce the current user to breathe in a specific cycle while providing the massage to the current user.

In the method of operating the massage device according to an embodiment of the present disclosure, the step of outputting the guide signal includes the steps of: a step of outputting a human voice explaining a breathing method in a first section to train the user to breathe; a step of outputting repetitive music in a second section to guide the breathing of the current user without the human voice; and a step of outputting music in the third section, which is different from the music of the second section.

In the method of operating the massage device according to an embodiment of the present disclosure, the step of outputting repetitive music includes at least one of the steps of: repeatedly changing the pitch of the sound from a first pitch to a second pitch for a first duration, and from the second pitch to the first pitch for a second duration; repeatedly changing the volume of the sound from a first volume to a second volume for the first duration, and from the second volume to the first volume for the second duration; and repeatedly changing the brightness of a display from a first brightness to a second brightness for the first duration, and from the second brightness to the first brightness for the second duration, wherein the first pitch is lower than the second pitch, the first volume is lower than the second volume, the first brightness is darker than the second brightness, and the first duration is shorter than the second duration.

In the method of operating the massage device according to an embodiment of the present disclosure, at least one of the first duration and the second duration in the second section is gradually lengthened.

In the method of operating the massage device according to an embodiment of the present disclosure, the step of providing a massage to the current user by using the massage module includes: a step in which the massage module moves to the position of the current user's shoulders while providing a kneading massage; and a step in which the massage module alternately provides a kneading massage and a swing massage at the position of the current user's shoulders for a third duration for each.

In the method of operating the massage device according to an embodiment of the present disclosure, the step of providing a massage to the current user by using the massage module includes: a step in which the massage module moves form the position of the current user's shoulders to the current user's hip area while providing a swing massage; and a step in which the massage module alternately provides a kneading massage and a swing massage at the current user's hip area for the third duration for each.

In the method of operating the massage device according to an embodiment of the present disclosure, the step of providing a massage to the current user by using the massage module includes: a step in which the massage module moves form the current user's hip area to the current user's waist area while providing a kneading massage; and a step in which the massage module alternately provides a kneading massage and a swing massage at the current user's waist area for the third duration for each.

The method of operating the massage device according to an embodiment of the present disclosure further includes: a step of controlling a distance between the left massage ball and the right massage ball included in the massage module to a second distance; a step in which the massage module moves form the current user's waist area to the current user's neck area while providing an acupressure massage; and a step in which the massage module alternately provides a kneading massage and a swing massage at the current user's neck area for the third duration for each.

The method of operating the massage device according to an embodiment of the present disclosure further includes: a step of controlling a distance between the left massage ball and the right massage ball included in the massage module to a second distance; a step in which the massage module moves form the current user's neck area to the current user's waist area while providing an acupressure massage; and a step in which the massage module alternately provides a kneading massage and a swing massage at the current user's waist area for the third duration for each.

In the method of operating the massage device according to an embodiment of the present disclosure, the step of providing a massage to the current user by using the massage module includes: a step in which the massage module moves form the current user's waist area to the current user's hip area while providing a kneading massage; a step in which the massage module provides at least one of a kneading massage, a swing massage, and a tapping massage at the current user's hip area for the third duration or more; a step of controlling a distance between the left massage ball and the right massage ball included in the massage module to a second distance; and a step in which the massage module moves form the current user's hip area to the current user's neck area while providing an acupressure massage.

Additionally, the program for realizing the method for operating the massage device as described above can be recorded on a computer-readable recording medium.

### Advantageous Effect

The massage device according to an embodiment of the present disclosure can provide massage modes which can help lower the user's blood pressure by inducing emotional stability through smooth blood circulation and respiratory relaxation.

The advantages of the present disclosure are not limited to the above-mentioned advantages, and other advantages, which are not specifically mentioned herein, will be clearly understood by those skilled in the art from the following description.

### DESCRIPTION OF DRAWINGS

FIG. 1 is a view for depicting a massage device according to an embodiment of the present disclosure.

FIG. 2 is a view for depicting a main frame according to an embodiment of the present invention.

FIG. 3 is a view illustrating a massage device according to an embodiment of the present invention.

FIG. 4 is a view illustrating an external device that can communicate with the massage device 100 according to an embodiment of the present invention.

FIG. 5 illustrates a control unit according to an embodiment of the present disclosure.

FIG. 6 is a flowchart illustrating the operation of the massage device according to an embodiment of the present disclosure.

FIG. 7 is a view for depicting the operation of the massage device according to an embodiment of the present disclosure.

FIG. 8 is a flowchart illustrating the operation of the massage device according to an embodiment of the present disclosure.

FIG. 9 is a view for depicting time intervals according to an embodiment of the present disclosure.

FIG. 10 is a view for depicting time intervals according to an embodiment of the present disclosure.

FIG. 11 is a view for depicting time intervals according to an embodiment of the present disclosure.

FIG. 12 is a view for depicting time intervals according to an embodiment of the present disclosure.

FIG. 13 is a flowchart for depicting a method for operating the massage device according to an embodiment of the present disclosure.

FIG. 14 is a view depicting a screen for selecting a user according to an embodiment of the present disclosure.

FIG. 15 is a flowchart illustrating a method for operating the massage device 100 according to an embodiment of the present disclosure.

### BEST MODE

A method for operating a massage device includes: a step of receiving an input from a current user to execute a massage mode for managing blood pressure: a step of determining the position of the current user's shoulders: a step of tilting a body massage unit included in the massage device backward: a step of measuring the current user's blood pressure by using a blood pressure measuring unit: a step of controlling a distance between a left massage ball and a right massage ball included in a massage module to a first distance: a step of providing a massage to the current user by using the massage module: and a step of outputting a guide signal to induce the current user to breathe in a specific cycle while providing the massage to the current user.

### MODE FOR INVENTION

Advantages and features of the present invention and methods accomplishing the advantages and features will become apparent from the following detailed description of exemplary embodiments with reference to the accompanying drawings. However, the present invention is not limited to exemplary embodiment disclosed herein but will be implemented in various forms. The exemplary embodiments are provided so that the present invention is completely disclosed, and a person of ordinary skilled in the art can fully understand the scope of the present invention.

Terms used herein will be briefly described, and the disclosed embodiments will be described in detail.

The terms including descriptive or technical terms which are used herein should be construed as having meanings that are obvious to one of ordinary skill in the art. However, the terms may have different meanings according to an intention of one of ordinary skill in the art, precedent cases, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

The singular forms of the components may be understood into the plural forms unless otherwise specifically stated in the context. Furthermore, the plural forms may include singular forms unless otherwise specifically stated in the context.

In the entire specification of the present invention, when a certain part “includes” a certain component, other components are not excluded unless explicitly described otherwise, and other components may in fact be included.

The term, “unit”, used in the present invention means a software element or a hardware element, and the “unit” performs some roles. However, the term, “unit”, is not limited to software or hardware. The “unit” may be configured in an addressable storage medium or may be configured to play one or more processors. Therefore, as an example, a “unit” includes elements, such as software elements, object-oriented software elements, class elements, and task elements, processes, functions, attributes, procedures, subroutines, segments of program codes, drivers, firmware, microcode, circuits, data, databases, data structures, tables, arrays, and variables. Functions provided within the elements and “units” may be combined with a smaller number of elements and “units” or may be further divided into additional elements and “units”.

According to an embodiment of the present invention, the “unit” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and the like. In some environments, a “processor” may refer to an application specific integrated circuit (ASIC), a programmable logic device (PLD), a field programmable gate array (FPGA), or the like. The term “processor” may refer to a combination of processing devices, such as a combination of a DSP genome and a microprocessor, a combination of a plurality of microprocessors, a combination of one or more microprocessors in combination with a DSP couple core, or a combination of any other such configurations.

The term “memory” should be interpreted broadly to include any electronic component capable of storing electronic information. The term memory may refer to various types of processor-readable media such as random access memory (RAM), read-only memory (ROM), non-volatile random access memory (NVRAM), programmable read-only memory (PROM), erase-programmable read-only memory (EPROM ACL), electrically erasable PROM (EEPROM), flash memory, magnetic or optical data storage, registers, and the like. Memory is referred to as being in electronic communication with the processor if the processor can read information from, and/or write information to, the memory. The memory integrated in the processor is in electronic communication with the processor.

In the present specification, an actuator refers to a configuration capable of providing a driving force. For example, the actuator may include a motor, a linear motor, an electronic motor, a DC motor, an AC motor, a linear actuator, an electric actuator, and the like, but is not limited thereto.

In this specification, according to one embodiment, the massage device may refer to a massage device including a body massage unit and a leg massage unit. Furthermore, according to another embodiment, the body massage unit 2100 and the leg massage unit 2300 may exist as separate individual devices (for example, a body massage device and a leg massage device), and the massage device can refer to either the body massage device or the leg massage device.

Hereinafter, embodiments of the present invention will be described in detail with reference to the accompanying drawings so as to be easily carried out by a person skilled in the art to which the present invention pertains. In addition, in order to clearly describe the present invention, portions irrelevant to the description will be omitted.

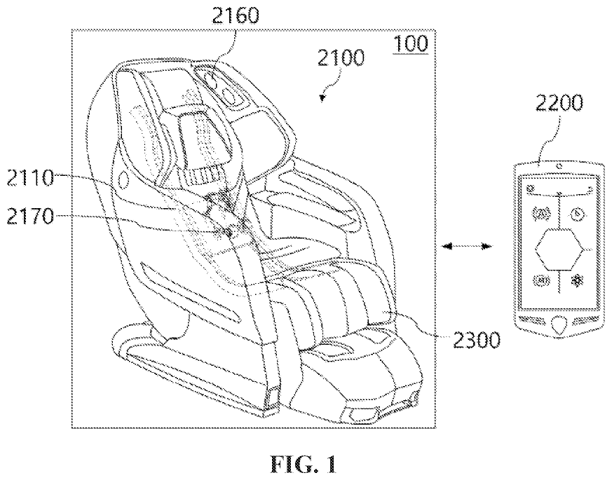

FIG. 1 is a view for depicting a massage device according to an embodiment of the present invention.

The massage device 100 according to an embodiment of the present invention has an area for accommodating at least a portion of the body of a user, and may include a body massage unit 2100 for massaging a user's body, and a leg massage unit 2300 for massaging the user's legs. For example, the leg massage unit 2300 can be positioned below the body massage unit 2100 to provide a massage to the user's legs.

The body massage unit 2100 may provide a massage to at least a portion of the body of the user. The body massage unit 2100 may include a massage module 2170, which provides a massage function to at least a portion of the body of the user, an audio output module 2160, which provides any type of audio output to the user, a main frame 2110 which forms the framework of the body massage unit 2100, and a user input unit 2180 which receives any type of input from the user.

The components included in the body massage unit 2100 are just exemplary embodiments, and the body massage unit 2100 may include other various components.

Additionally, the shape and the structure of the massage device 100 illustrated in FIG. 1 are just examples, and various forms of massage device 100 can be included within the scope of the present invention without departing from the scope of the present invention defined by the claims of the present invention.

The body massage unit 2100 can form a space of any shape to accommodate the user. The body massage unit 2100 may have a space with the shape corresponding to the shape of the body of the user. For example, as illustrated in FIG. 1, the body massage unit 2100 can be realized as a seat type that can accommodate the user's whole body or a portion of the body and can support at least a portion of the body of the user. For example, the body massage unit 2100 may include a backrest supporting at least a portion of the user's upper body, and a seat supporting at least a portion of the user's lower body.

A portion of the body massage unit 2100 which contacts the ground may include any material and/or component (for example, a non-slip pad) for increasing frictional force, and may include wheels for enhancing mobility of the massage device 100.

At least a portion of the body massage unit 2100 can slide. For instance, when the body massage unit 2100 starts a massage, at least a portion of the body massage unit 2100 can slide forward. Additionally, the body massage unit 2100 can be tilted backward. As a result, the body massage unit 2100 can provide a massage while tilted backward.

According to one embodiment of the present invention, the massage device 100 may include at least one air cell (not shown: airbag). The air cell can be located in the user's shoulders area, pelvic area, arm massage unit, leg massage unit 2300, and the like, but is not limited thereto and can be positioned in various parts of the massage device 100. The arm massage unit can be located on both sides of the body massage unit 2100 to provide a massage to the user's arms.

The massage device 100 may include an air supply unit, which can inflate the air cell by supplying air to the air cell. The air supply unit may be located inside the body massage unit 2100 or may be located in the leg massage unit 2300. In addition, the air supply unit can be located outside the massage device 100.

The leg massage unit 2300 may provide a leg massage to the user. For instance, the leg massage unit 2300 may include a calf massage unit which massages the user's calf and/or a foot massage unit which massages the user's foot.

The leg massage unit 2300 can be adjustable in length according to the user's body characteristics. For example, when a user who is tall uses the massage device 100, it is necessary to extend the length of the leg massage unit 2300 since the user's calves are long. Moreover, when a user who is short uses the massage device 100, it is necessary to reduce the length of the leg massage unit 2300 since the user's calves are short. Accordingly, the leg massage unit 2300 can provide a leg massage tailored to the user's height.

The massage module 2170 can be provided inside the body massage unit 2100 to offer any form of mechanical stimulation to the user accommodated in the body massage unit 2100. As depicted in FIG. 1, the massage module 2170 can move along the main frame 2110 provided inside the body massage unit 2100.

For instance, the main frame 2110 of the body massage unit 2100 can be equipped with a rack gear, and the massage module 2170 can move along this rack gear, providing mechanical stimulation to various parts of the user's body. The massage module 2170 may include a ball massage unit and/or a roller massage unit, but is not limited thereto.

The main frame 2110 serves as the structural backbone of the internal configuration of the body massage unit 2100 and can be made from materials such as metal or plastic. For example, the main frame 2110 can be implemented using iron, alloy, steel, among others, but is not limited thereto and can be made of various durable materials.

According to an embodiment of the present invention, the massage device 100 may include an audio output module 2160. The audio output module 2160 may be provided in various locations. For example, the audio output module 2160 may include multiple output units such as a top audio output unit placed on the top of the seat portion in contact with the user, a front audio output unit coupled to the front end of the arm massage unit 1200 on both sides of the seat portion, and/or a rear audio output unit coupled to the rear end of the arm massage unit 1200, but is not limited thereto. In this case, the audio output module 2160 can provide stereophonic sound such as 5.1 channels, but is not limited thereto. The arm massage unit can be located on at least one of both sides of the body massage unit 2100 to provide a massage to the user's arms.

According to an embodiment of the present invention, the user can control the massage device 100 using a massage device control device 2200. The massage device control device 2200 can be connected to the massage device 100 through wired communication and/or wireless communication.

The massage device control device 2000 may include at least one user device (personal device), such as a remote controller, a cellular phone, and a PDA (Personal Digital Assistant), but is not limited thereto, and may include various electronic devices that can be connected to the massage device 100 through wired or wireless communication.

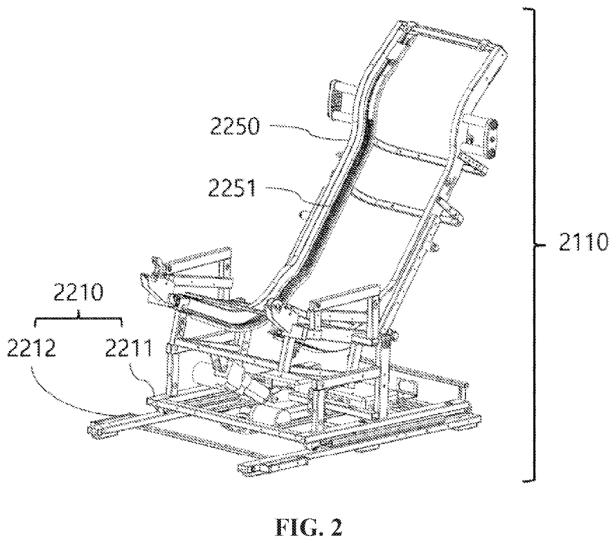

FIG. 2 is a view for depicting a massage device according to an embodiment of the present invention.

According to an embodiment of the present invention, the main frame 2110 may include an upper frame 2250, on which a massage module 2170 is equipped, and a base frame 2210 that supports the upper frame 2250.

A rack gear 2251 may be provided on at least a portion of the upper frame 2250. The rack gear 2251 may include a plurality of teeth and a plurality of valleys, as a member guiding the vertical movement of the massage module 2170.

According to an embodiment of the present invention, the rack gears 2251 may be provided on both sides of the upper frame 2250 to face each other, and the massage module 2170 may move along the rack gear 2251.

In FIG. 2, the rack gears 2251 are formed in the vertical direction, but are not limited thereto. The rack gear 2251 may include a front-rear direction rack gear and a vertical rack gear. The forward direction in the present invention means the direction heading the user from the massage module 100, the rearward direction means the direction heading the body massage module 2170 from the user. The The front-rear direction may means the Z-axis direction.

The massage module 2170 may include a gear that meshes with the rack gear 2251. More specifically, the massage module 2170 may include gears that respectively mesh with a front-rear direction rack gear and a vertical rack gear. By the rotation of the gear by an actuator equipped on the massage module 2170, the massage module 2170 can move forward, backward, upward, or downward.

As the massage module 2170 moves forward, the intensity of the massage may increase. Additionally, as the massage module 2170 moves backward, the intensity of the massage may decrease.

The rack gear 2251 may be made of metal and/or plastic materials. For example, the rack gear 2251 may be made of iron, steel, alloy, reinforced plastic, melamine resin, phenolic resin, etc., but is not limited thereto.

The upper frame 2250 may be realized in various shapes. For instance, the upper frame 2250 may be classified into an S-frame, an L-frame, an S&L frame, a double S&L frame according to shapes, but is not limited thereto.

The S-frame refers to a frame where at least a portion of the upper frame 2250 includes a curved shape like “S”. The L-frame means a frame that includes a bent shape like “L” in at least a portion of the upper frame 2250. The S&L frame means a frame including an “S”-shaped curved form and an “L”-shaped bent form. The double S&L frame means a frame including an “L”-shaped bent form and two “S”-shaped curved forms.

The base frame 2210 means a part which supports the upper frame 2250 and contacts the ground or the installation surface of the massage device 100. The base frame 2210 may include an upper base frame 2211 and a lower base frame 2212.

The upper base frame 2211 may support the upper frame 2250, and the lower base frame 2212 may come into contact with the ground or the installation surface of the massage device 100. Additionally, the upper base frame 2211 can be positioned to contact the lower base frame 2212.

According to an embodiment of the present invention, the upper base frame 2211 can move along the lower base frame 2212. For instance, the upper base frame 2211 can slide forwards and/or backward along the lower base frame 2212. In this case, the upper frame 2250 is connected to the upper base frame 2211, can move according to the movement of the upper base frame 2211.

For example, when the upper base frame 2211 moves forward, the upper frame 2250 can also move forward, and when the upper base frame 2211 moves backward, the upper frame 2250 can also move backward. As a result, the sliding movement of the body massage unit 2100 can be permitted.

In detail, to allow the movement of the upper base frame 2211, a moving wheel may be provided on the underside of the upper base frame 2211. Additionally, a guide member, which can guide the moving wheel, may be provided on the top of the lower base frame 2212. The moving wheel provided on the upper base frame 2211 can move along the guide member provided on the lower base frame 2212, allowing for the forward and/or backward movement of the upper base frame 2211.

According to another embodiment of the present invention, the massage device 100 may not provide a sliding function, and in this case, the base frame 2210 may not be separated into upper and lower frames.

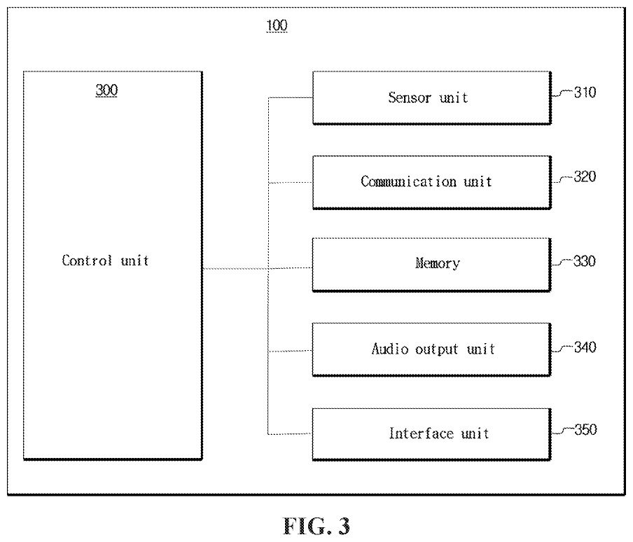

FIG. 3 is a view for depicting a detailed configuration of a massage device according to an embodiment of the present invention.

According to an embodiment of the present invention, the massage device 100 may include at least one among a control unit 300, a sensor unit 310, a communication unit 320, memory 330, an audio output unit 340, and an input unit 350. The control unit 300 may include at least one processor and memory. The at least one processor can execute instructions stored in memory.

The control unit 300 can control the operation of the massage device 100. The control unit 300 may include one processor and may include multiple processors. If the control unit 300 includes multiple processors, at least some of the multiple processors can be located at physically separated distances. Furthermore, the massage device 100 is not limited thereto and can be realized in various ways.

According to an embodiment of the present invention, the control unit 300 may control the operation of the massage device 100. For instance, the massage device 100 may include a plurality of actuators, and the control unit 300 can control the operation of the massage device 100 by controlling the operation of the plurality of actuators. For example, the massage device 100 may include at least one among a driving unit that moves the armrest frame support, a massage module 2170 moving actuator, at least one actuator included in the massage module 100, a back angle actuator, a leg angle actuator, a foot massage actuator, a leg length adjustment actuator, and a sliding actuator. The control unit 300 controls them to control the operation of the massage device 100.

The massage module moving actuator is an actuator capable of moving the massage module 2170 vertically, so the massage module 2170 can move along the rack gear by the operation of the massage module 2170 moving actuator.

The back angle actuator is an actuator that adjusts the angle of a part of the massage device 100 contacting with the user's back, and the back angle of the massage device 100 can be adjusted by the operation of the back angle actuator.

The leg angle actuator is an actuator to adjust the angle of the leg massage unit 2300 of the massage device 100, and the angle between the leg massage unit 2300 and the body massage unit 2100 can be adjusted by the operation of the leg angle actuator.

The foot massage actuator represents an actuator that operates the foot massage module included in the leg massage unit 2300. The massage device 100 can provide a foot massage to the user using the foot massage actuator.

The massage module 2170 may include at least one actuator, and the control unit 300 can provide various massage actions by operating at least one actuator. For instance, the control unit 300, by operating at least one actuator included in the massage module 2170, can provide massages such as tapping and kneading, but is not limited thereto and can provide various other massage actions.

The leg length adjustment actuator represents an actuator adjusting the length of the leg massage unit 2300. For example, the control unit 300 can adjust the length of the leg massage unit 2300 to fit the user using the leg length adjustment actuator, and as a result, the user can receive a massage suited to the body shape.

The sliding actuator enables the sliding motion of the massage device 100. For instance, a horizontal base upper frame can move forward and/or backward due to the operation of the sliding actuator, so that the upper frame connected to the horizontal base upper frame also moves forward and/or backward.

The memory 330 may be included in the control unit 300 or located outside the control unit 300. The memory 330 can store various pieces of information related to the massage device 100. For example, the memory 330 may contain massage control information and personal authentication information, but is not limited thereto.

The memory 330 can be realized through a non-volatile storage medium, which can continuously store arbitrary data. For example, the memory 330 may include storage devices based on a disk, an optical disk, a magneto-optical storage device, a flash memory and/or a battery-backed memory, and is not limited thereto.

The memory 330 is a primary storage device directly accessed by the processor, such as a random access memory (RAM) like a dynamic random access memory (DRAM) and a static random access memory (SRAM), and means a volatile storage device in which stored information is instantly erased when power is turned off, but it is not limited thereto. The memory 330 can be operated by the control unit 300.

The massage device 100 may include a sensor unit 310. The sensor unit 310 can acquire various information using at least one sensor. The sensor unit 310 can be equipped with sensors using measurement means such as pressure, potential, and optics. For example, the sensor unit may include a pressure sensor, an infrared sensor, an LED sensor, a touch sensor, an electrode sensor, an air pressure measurement sensor, and is not limited thereto.

The sensor unit 310 may include a biometric information acquisition sensor. The biometric information acquisition sensor can acquire at least one of fingerprint information, face information, voice information, iris information, weight information, blood pressure information, heartbeat (or heart rate) information, electrocardiogram information, body composition information, but is not limited thereto, and may include various biometric information.

According to another embodiment of the present invention, the massage device 100 can detect a contact area and/or contact position with the user through the sensors. Moreover, the massage device 100 can provide a customized massage based on the information acquired through the sensors. Moreover, the massage device 100 may include a communication unit. The communication unit of the massage device 100 may receive a signal from an external device. The control unit 300 can process the received signal and obtain a result signal. The communication unit can output the result signal to the external device.

The communication unit 320 can communicate with an internal module of the massage device 100, an external massage device and/or a user terminal via any type of network. The communication unit may include a wired/wireless connection module for network access. For wireless connection technology, for example, there are WLAN (Wireless LAN) (Wi-Fi), Wibro (Wireless broadband), Wimax (World Interoperability for Microwave Access), HSDPA (High-Speed Downlink Packet Access), and the like. For wired connection technology, for instance, there are XDSL (Digital Subscriber Line), FTTH (Fibers to the home), PLC (Power Line Communication), and the like. In addition, the network connection unit may include a short-range communication module, which allows data transmission and reception with any device/terminal located in close range. For short-range communication technology, there are Bluetooth, RFID (Radio Frequency Identification), IrDA (infrared Data Association), UWB (Ultra-Wideband), ZigBee, and the like, and the communication technologies are not limited thereto.

Furthermore, the massage device 100 may further include an input unit 350 or an output unit. The massage device 100 may receive an input from the user using the input unit 350. Additionally, the massage device 100 can output the processing result of the control unit 300 to the output unit. The input unit 350 and the output unit may be implemented as one device by being integrated. For example, a touch screen can output an image as soon as receiving an input from the user.

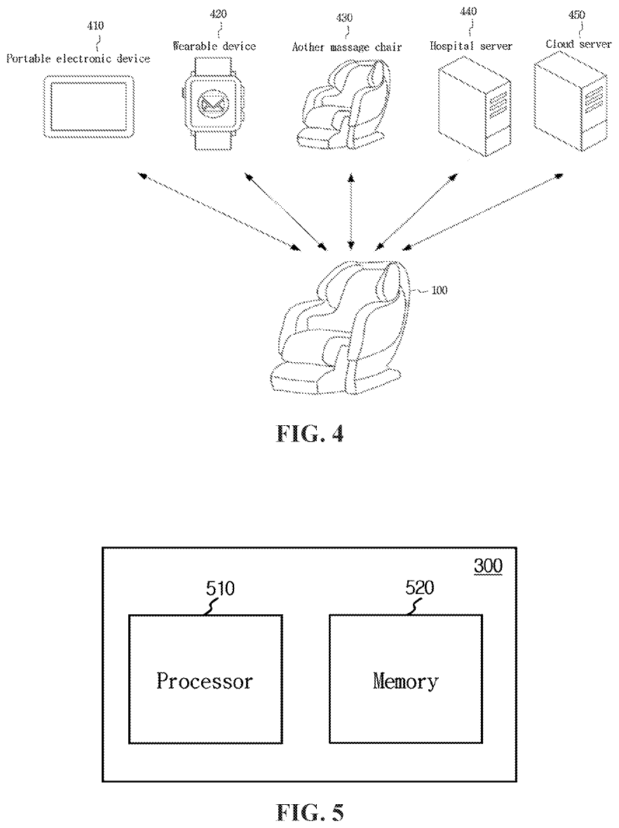

Specifically, the input unit 350 can receive commands related to the operation control of the massage device 100 from the user, and the input unit 350 may be realized in various forms. For example, the input unit 350 can be equipped in the body massage unit 2100, and can be equipped in the leg massage unit 2300, but is not limited thereto. In addition, the input unit 350 may include a user input unit 2180, a massage device control device 2000, and/or various external devices to be described in FIG. 4.

The massage device 100 can acquire various commands from the user through the input unit 350. For example, the massage device 100 can receive any command for selection of the massage module, selection of massage type, selection of massage intensity, selection of massage time, selection of the massage area, selection related to the position and operation of the body massage unit 2100, on-off selection for the power of the massage device 100, selection regarding the operation of the heat function, selection related to music playback, and more, but it is not limited thereto.

The massage device 100 can provide an interface for selecting the massage mode. For example, the input unit 350 and/or output unit may include a massage device control device 2000. Various modes of medical massage-related to body improvement can be listed through the massage device control device 2000.

The medical massage mode may include at least one among a focus mode, a meditation mode, a recovery mode, a stretching mode, a sleep mode, a vitality mode, a golf mode, a hip up mode, a student mode, a zero gravity mode, and a growth mode.

The massage modes can correspond to a list of massage patterns. The list of massage patterns can vary depending on the massage modes. The list of different massage patterns can be predetermined according to the massage modes. The list of massage patterns can include a plurality of massage patterns. The list of massage patterns can be a chronological arrangement of massage patterns that the massage device 100 will perform. The massage device can perform the massage patterns from the top of the list. The massage device can sequentially perform the plurality of massage patterns included in the list to provide a massage to the user.

The massage patterns can be defined by information about the massage patterns. The information of the massage pattern can represent a combination of at least one among the massage module to be used, an airbag, types of massage, duration of massage, intensity of massage, locations for massage, temperature of the massage device, and postures of massage.

The location of massage can refer to the body part of the user that the massage device 100 massages. The massage device 100 can control the actuators in the corresponding area to provide a massage to the user's body part. The massage device can massage at least one area simultaneously. For example, the massage device 100 can simultaneously massage at least one of the arms, legs, feet, and/or back.

The types of massage can include at least one of tapping, kneading, palm tapping, compound massage, acupressure, swing, and/or swing tapping. The massage device 100 can control the massage module and/or the air cell based on information about the type of massage. The massage device 100 can provide at least one type of massage, such as tapping, kneading, palm tapping, compound massage, acupressure, swing, and swing tapping based on the information of the types of massage.

The duration of massage represents the time that the massage device 100 provides the massage pattern to the user. The massage device 100 can determine the time to provide the massage pattern to the user based on the information of the duration of massage.

The intensity of massage represents the strength with which the massage device 100 presses, kneads, or taps the user. The massage device 100 can control the actuators to adjust the strength of pressing, kneading, or tapping the user. The strength of pressing, kneading, or tapping can vary depending on the body part.

According to another embodiment of the present invention, the input unit 350 can be equipped with buttons in the form of a hot key and/or selection buttons to execute direction selection, cancellation, and input, depending on pre-set user settings or its own pre-set functions.

The input unit 350 can be realized as a touchscreen, a keypad, a dome switch, a touch pad (pressure/static), a jog wheel, a jog switch, and others, but is not limited thereto. Moreover, the input unit 350 can acquire commands through the user's speech based on voice recognition technology.

According to an embodiment of the present invention, the output unit may include a display for displaying the operating situation of the massage device 100 or the current status of the user. In this case, the display may include at least one of a liquid crystal display (LCD), a thin film transistor-liquid crystal display (TFT LCD), an organic light emitting diode (OLED), a flexible display, a 3D display, and the like, but is not limited thereto.

The output unit may include an audio output unit 340. The audio output unit 340 of FIG. 3 may include the audio output module 2160 of FIG. 1. The audio output unit 340 can provide any type of audio output to the user. For example, the audio output unit 340 can provide brain stimulation to the user by outputting music and/or binaural beats optimized for the massage pattern provided by the massage device 100. The audio output unit 340 can output an acoustic signal received through a network (not illustrated) or stored in an internal/external storage medium (not illustrated). For instance, the audio output unit 340 can output music controlled by the user's terminal through a network connection (e.g., a Bluetooth connection) with the user's terminal. In addition, the audio output unit 340 can output any type of acoustic signal related to the operation of the massage device 100.

A person of ordinary skill in the technical field to which the present invention belongs would know well that the present invention can be realized by being combined with other program modules and/or by a combination of hardware and software. For example, the present invention can be realized by a computer-readable medium.

A medium accessible by a computer can be any computer-readable medium, and such a computer-readable medium includes volatile and non-volatile media, transitory and non-transitory media, and removable and non-removable media. As an example, without limitation, a computer-readable medium may include a computer-readable storage medium and a computer-readable transmission medium.

The computer-readable storage medium includes volatile and non-volatile, transitory and non-transitory, removable and non-removable media realized by any method and/or technology for storing information such as computer-readable instructions, data structures, program modules, and/or other data. The computer-readable storage medium includes RAMs, ROMs, EEPROMs, flash memories and/or other memory technology, CD-ROMs, digital video disks (DVD) and/or other optical disk storage devices, magnetic cassettes, magnetic tape, magnetic disk storage devices and/or other magnetic storage devices, or any other medium that can be accessed by a computer and used to store desired information, but is not limited thereto.

FIG. 4 is a view illustrating an external device that can communicate with a massage device according to an embodiment of the present invention.

The massage device 100 can transmit and receive various data through wired and/or wireless communication with the external device.

The external device may include a portable electronic device 410 such as an AI speaker, a tablet, or a smartphone. In the present disclosure, the portable electronic device 410 can correspond to a user terminal. The portable electronic device 410 may be dedicated to the massage device 100 or may be a general-purpose portable electronic device. In addition, the external device may include a wearable device 420 such as a smartwatch or a smart band. The external device may include another massage device 430 that the user is not currently using. The external device may include a hospital server 440. The external device may include a personal health record (PHR) server. Additionally, the external device may include a cloud server 450. The external device may include a medical measurement device such as an electronic scale, a blood glucose meter, or a blood pressure meter.

In this invention, examples of the external device have been described, but any device that can communicate with the massage device 100 wirelessly or by wire and exchange information may all be regarded as external devices.

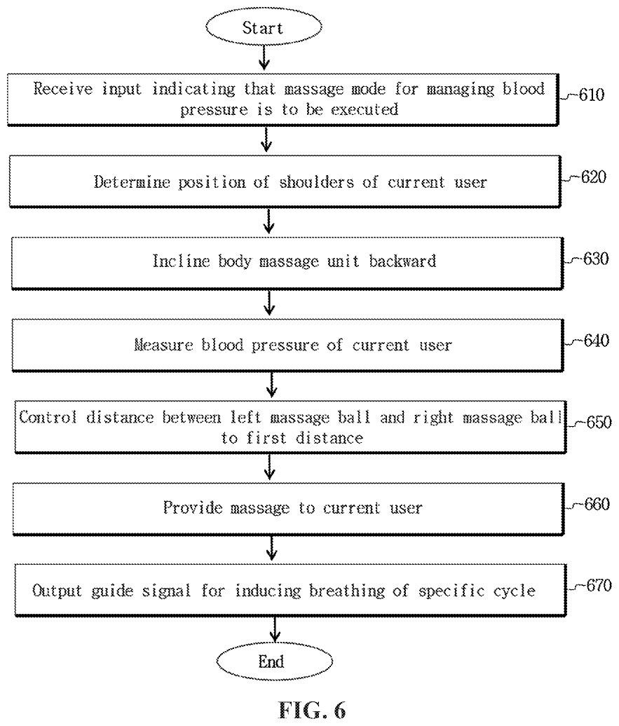

FIG. 5 illustrates a control unit according to an embodiment of the present disclosure.

The massage device can include a control unit 300. The control unit 300 can include at least one of a processor 510 and a memory 520. The memory 520 can be the same as the memory 330. The processor 510 can perform operations based on instructions stored in the memory 520. The instructions stored in the memory 520 can be applications installed in the control unit 300. However, the control unit 300 is not limited thereto, and may include only the processor 510 without the memory. The processor 510 can be set to output a pre-set signal to an output line for a pre-set duration based on input signals. Each component of the control unit 300 can perform pre-set operations based on the signals. Hereinafter, the operations of the control unit 300 will be described in more detail.

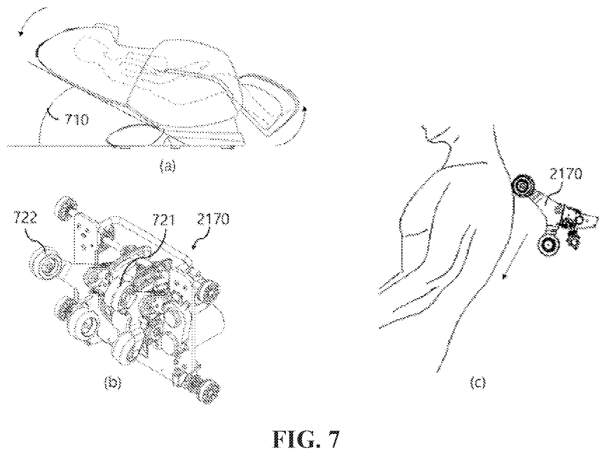

FIG. 6 is a flowchart illustrating the operation of the massage device according to an embodiment of the present disclosure. FIG. 7 is a view for depicting the operation of the massage device according to an embodiment of the present disclosure.

The massage device 100 for measuring a user's blood pressure according to an embodiment of the present disclosure includes a control unit 300 which controls the massage device, a body massage unit which provides a massage to the user's upper and lower body parts according to the control of the control unit, and an arm massage unit which is arranged on at least one of the left and right sides of the body massage unit to provide a massage to the user's arms according to the control of the control unit. The arm massage unit can include a massage air cell which is arranged along the inner wall of the arm massage unit to provide a massage to the user's arms, and an air cell cover which surrounds the massage air cell to protect the exterior of the massage air cell.

The arm massage unit can include a blood pressure measuring unit. The blood pressure measuring unit can include at least one blood pressure measuring air cell, and at least one of an air cell cover, an air supply unit, and an air pressure sensor. More specifically, the arm massage unit can include at least one blood pressure measuring air cell used for measuring blood pressure and an air cell cover surrounding the blood pressure measuring air cell to protect the exterior of the blood pressure measuring air cell. The arm massage unit can include an air supply unit for supplying air to at least one of the massage air cell or the blood pressure measuring air cell. Furthermore, the arm massage unit can include an air pressure sensor for measuring the air pressure in the blood pressure measuring air cell. When measuring blood pressure, the control unit 300 can supply air to the blood pressure measuring air cell using the air supply unit and measure an air pressure change using the air pressure sensor. The control unit 300 can measure the user's blood pressure based on the air pressure change.

The massage device 100 can perform a step 610 of receiving input indicating to execute a massage mode for managing blood pressure from a current user. The massage device 100 can determine the current user based on the user's input. For instance, the massage device 100 can display a user list on a display based on a family tree database. The user can select the user from the user list. Based on the user's input, the massage device 100 can determine the current user.

The massage device 100 can display at least one massage mode on the display. Furthermore, the massage device 100 can receive the selection of one massage mode from the user. The selected massage mode can be a massage mode for managing blood pressure, but is not limited thereto. After determining the current user, the massage device 100 can acquire information related to the current user's blood pressure from the memory. The information related to blood pressure can include information on whether there is a person with high blood pressure in the family, whether the current user has high blood pressure, whether the current user drank alcohol, whether the current user smoked, or whether the current user takes antihypertensive drug.

The massage mode for managing blood pressure can be a blood pressure only massage mode for inducing emotional stability through smooth blood circulation and respiratory relaxation through a dedicated massage mode of a massage chair for a hypertensive patient. Although the treatment of hypertension fundamentally involves drug administration, the massage device 100 can help blood pressure drop by providing a non-pharmacological treatment method which can be used in conjunction with medication through the massage mode for managing blood pressure. The massage device 100 can provide a massage mode for managing blood pressure for 10, 20, or 30 minutes, according to the user's selection.

The massage device 100 can apply acupressure to specific acupoints by using massage balls to smoothly circulate a vertical flow of energy and blood and facilitate blood circulation. In addition, the massage device 100 can further enhance blood circulation by stimulating the Baihui point located at the nape of the neck and the Fengchi point located slightly more outward. Here, the Fengchi point is an acupoint located midway of the line connecting the Fengfu point and the earlobe. The massage device 100 can invigorate the user's vital energy, regulate blood pressure, and help to prevent stroke by pressing the Fengchi point. Moreover, the Baihui point is located at the boundary between the neck and hairline. The massage device 100 stimulates the Baihui point to relax the user's muscles, promote blood circulation in the head, thereby helping to alleviate conditions like migraines, chronic fatigue, eye fatigue, rhinitis, and hypertension.

In addition, the massage device 100 can massage the neck and the lower pelvis area, which are key distribution locations for the parasympathetic nervous system, thereby activating the parasympathetic nerves. When the user's sympathetic nervous system is overactive, the user might constantly feel heat in the face, the chest, and the back of the neck, experience rapid breathing, palpitations, and frequent sweating. Overactivity of the sympathetic nervous system may lead to inadequate delivery of blood, oxygen, and nutrients to the peripheral blood vessels, so may potentially lead to the destruction of red blood cells which supply oxygen to cells. Conversely, when the user's parasympathetic nervous system is activated, the autonomic nervous functions maintain balance, the red blood cells in the blood are healthy, and blood and oxygen supply to the extremities is smooth, such that hands and feet are always warm, blood circulation is smooth, and muscles are relaxed. Therefore, the massage device 100 can improve blood circulation and metabolic flow in the user by activating the parasympathetic nervous system. Even if the user is stressed, the massage device 100 can quickly stabilize blood pressure and restore muscle tension to normal by continuously maintaining the health of the parasympathetic nervous system. Accordingly, the massage device 100 can help to balance the user's autonomic nervous system, solve problems of blood circulation and blood flow, and help to recover the overall health.

Referring to FIG. 6, the massage device 100 can perform a step 620 of determining the position of the current user's shoulders. The massage device 100 can determine the position of the current user's shoulders by using the massage module 2170. For instance, the massage device 100 can determine the position of the user's shoulders by moving the massage module 2170 from the top to the bottom of the body massage unit 2100. The massage module 2170 can move from top to bottom along the rack gear driven by the actuator. Referring to FIG. 7(c), when the massage module 2170 meets the user's shoulders while moving from the top to the bottom, the load of the massage module moving actuator which vertically moves the massage module 2170 can increase. The massage device 100 can determine the position of the user's shoulders based on the load of the massage module moving actuator. However, the present disclosure is not limited thereto, and various methods can be used to measure the user's shoulders.

The massage device 100 can perform a step 630 of tilting the body massage unit included in the massage device 100 backward. Referring to FIG. 7(a), the massage device 100 can tilt the body massage unit backward and lift the leg massage unit. For example, an angle 710 formed between the body massage unit and the ground can be 130 degrees or more and 160 degrees or less. The user can be in an almost lying position. For example, the angle formed between the body massage unit and the ground can be 135 degrees or 150 degrees. When the user is in the almost lying position by adjusting the angle of the body structure which accommodates the user's body, the massage device 100 can minimize the gravity applied to the human body and allow the user to achieve the most comfortable posture.

To accurately measure the user's blood pressure, the massage device 100 can tilt the body massage unit backward so that the height of the user's wrist is almost equal to the height of the user's heart. For this purpose, the massage device 100 can determine the height of the user's heart and the height of the wrist.

More specifically, the massage device 100 can perform the following process to align the height of the user's heart with the wrist height before measuring blood pressure. The massage device 100 can perform a step of acquiring the position of the user's heart. The massage device 100 can perform a step of acquiring the position of the user's wrist. Here, the positions of the heart and the wrist may be the positions when the massage device 100 is in the initial state. Here, the initial state may mean the state when the massage device 100 is not reclined, or the state in which the body massage unit is in an upright position. Furthermore, the massage device 100 can perform a step of determining the tilt of the body massage unit to align the position of the user's wrist with the position of the heart. In addition, the massage device 100 can be reclined based on the tilt of the body massage unit. Here, the positions of the wrist and the heart area may mean the height of the wrist and the heart from the ground, respectively. Reclining the massage device 100 may mean tilting the body massage unit backward.

The massage device 100 can determine the position (height) of the user's heart based on the determined position of the current user's shoulders. For instance, the massage device 100 can determine that the user's heart is located at a predetermined distance below from the position of the current user's shoulders along the main frame 2110. Here, the term, “below”, may mean the direction from the head to the hips when the user sits in the massage device 100.

According to another embodiment of the present disclosure, the massage device 100 can determine the position of the user's heart area based on the user's input. The massage device 100 can acquire information related to the user's body from the user's input. The information related to the user's physical body can include the user's height, sitting height, or age. The massage device 100 can store the user's height and a heart height table which correlates to the height of the heart from the seat, based on statistical data. The massage device 100 can obtain the height of the heart from the seat, which corresponds to the received user's height, from the heart height table.

Additionally, the massage device 100 can output a guidance message to have the user place the hand at a specific position. For example, the massage device 100 can accommodate the user's hand inside the arm massage unit. Accordingly, the massage device 100 can approximately acquire the position of the user's wrist since the arm massage unit is fixed relative to the massage device 100. The user might need to place the wrist at a specific position to measure blood pressure. For example, the specific position for placing the wrist may be the location of a specific air cell in the arm massage unit. Here, the specific air cell may be an air cell for massaging the user's wrist. Since the position of the specific air cell in the arm massage unit is predetermined information, the massage device 100 can acquire the position of the specific air cell from the memory. However, the present disclosure is not limited thereto. If necessary, the user can change the position of the specific air cell to receive a massage, and the massage device 100 can also change the position of the specific air cell using sensors. The position of the specific air cell can be the position of the user's wrist. Moreover, the position (height) of the specific air cell can be the height of the user's wrist from the ground.

The massage device 100 can perform a step of determining the tilt of the body massage unit to align the position of the user's wrist with the position of the heart area. The massage device 100 can determine the tilt of the body massage unit based on a predetermined formula or a predetermined table. More specifically, the massage device 100 can determine the tilt of the body massage unit based on the following formula:

$$\\ r = ( A - C ) / ( B + D )$$

‘A’ may represent the position of the user's heart area in the initial state of the massage device. The initial state of the massage device may mean the state in which the massage device is not reclined. ‘A’ can be greater than zero. Moreover, ‘C’ can represent the position of the user's wrist in the initial state of the massage device. ‘C’ can be greater than zero. ‘B’ can be a constant representing the change in the position of the heart area according to the tilt. ‘B’ can be greater than zero. ‘D’ can be a constant representing the change in the position of the wrist according to the tilt. ‘D’ can be equal to or greater than zero. ‘r’ can represent the tilt of the body massage unit. ‘r’ can represent the tilt degree of of the body massage unit from the initial state. In addition, ‘A’ is the measured position of the heart area, and ‘B, C, and D’ can be predetermined values.

In summary, as the tilt of the body massage unit increases, the position of the user's heart area can become lower. As the tilt of the body massage unit increases, the position of the user's wrist can become higher. Rearranging the formula, the tilt ‘r’ of the body massage unit can be as follows:

$$r = ( A - C ) / ( B + D )$$

The massage device 100 can recline the body massage unit based on the tilt of the body massage unit. Therefore, the massage device 100 can almost align the position of the user's heart area with the position of the wrist.

The above formula utilizes the linearity of the height of the heart and the height of the wrist according to the tilt. When utilizing linearity, since lots of processing power is not required, the massage device operates quickly and can be realized at a low cost. However, the massage device is not limited thereto. So, in the formula, ‘r’ can be equal to arc tan (E/L), namely, r=arc tan (E/L). The formula may assume that the body massage unit of the initial state is perpendicular to the ground. Here, ‘E’ may represent the height of the heart from the seat part (seat). ‘E’ can be measured or received as already described. Additionally, ‘L’ may represent the difference between the z-axis position of the heart and the z-axis position of the wrist. The z-axis may mean the front-rear direction of the massage device 100. That is, when the user sits in the massage device 100, the front or the rear direction can be in the z-axis direction.

Furthermore, ‘r’ can be acquired based on the following formula. The formula can be E*sin(R−r)=L*sin(r), wherein ‘R’ is an angle formed between the ground and the body massage unit in the initial state. In such a case, although it is possible to accurately align the position of the heart and the position of the wrist, the performance of the control unit must be high, and the computation speed may be slow.

The massage device 100 can determine the tilt of the body massage unit based on a predetermined table. The massage device 100 may store a table correlating the tilt of the body massage unit according to the user's height or the position of the heart area. As described above, once the user's height or the position of the heart area is determined, the massage device 100 can decide the tilt of the body massage unit based on the table. Moreover, the massage device 100 can recline the body massage unit based on the tilt of the body massage unit. Therefore, the massage device 100 can almost accurately match the position of the user's heart and the position of the user's wrist.

When the user selects a massage mode for managing blood pressure, the massage device 100 can perform a step 640 of measuring the current blood pressure of the user by using the blood pressure measuring unit. The massage device 100 can output a message for measurement when measuring the user's blood pressure. For example, messages, such as “Starting to measure blood pressure now. Please check if your wrist is placed in position”, and “Measuring blood pressure”, can be output. If the massage device 100 fails in measuring blood pressure, the massage device 100 can output a message, such as “Blood pressure measurement failed. Please check again if your wrist is placed in position.” If the massage device 100 succeeds in measuring blood pressure, the massage device 100 can output a message such as “Blood pressure measurement is complete.”

When the user selects the massage mode for managing blood pressure, the massage device 100 can further perform the following process.

Referring to FIG. 6, the massage device 100 can perform a step 650 of controlling a distance between a left massage ball 721 and a right massage ball 722 in the massage module 2170 as a first distance. As illustrated in FIG. 7(b), the left massage ball 721 and the right massage ball 722 can move laterally within the massage module 2170. The left massage ball 721 can move to the right and the right massage ball 722 can move to the left, such that the left massage ball 721 and the right massage ball 722 can be closer to each other. Alternatively, The left massage ball 721 can move to the left and the right massage ball 722 can move to the right, such that the left massage ball 721 and the right massage ball 722 can be farther apart from each other. The first distance can be a predetermined distance. The first distance may be a distance between the left massage ball 721 and the right massage ball 722 when the left massage ball 721 and the right massage ball 722 are closest to each other. Here, the left and the right may mean the user's left and right when the user sits in the massage device 100.

The massage device 100 can perform a step 660 of providing a massage to the current user by using the massage module 2170. The massage device 100 can move vertically the massage module 2170 by using the massage module moving actuator. The massage device 100 can acquire the current position of the massage module 2170 by an encoder included in the massage module moving actuator. The current position of the massage module 2170 may mean the position of the massage module 2170 on the rack gear of the main frame.

The massage device 100 can provide a massage based on the determined position of the user's shoulders. For example, the massage module can determine that the neck area is located a predetermined distance above the shoulder position. Therefore, to massage the back of the neck, the massage device 100 can move the massage module 2170 above the shoulder position.

In addition, the massage device 100 can store the position of the seat part in the memory. The massage device 100 can divide the upper body distance ranging from the determined shoulder position to the seat part into n parts. For instance, the massage device 100 can determine a distance ranging from the position of the seat part to a k/n point of the upper body distance as the buttock part. The massage device 100 can determine a distance ranging from the k/n point to a (k+m)/n point of the upper body distance as the waist part. Additionally, the massage device 100 can determine a distance ranging from the (k+m)/n point of the upper body distance to a (k+m+l)/n point as the user's back part. Furthermore, the massage device 100 can determine a distance ranging from the (k+m+l)/n point to the position of the shoulder as the user's shoulders part. The massage device 100 can divide the buttocks, waist, back, and shoulder areas into h parts.

Here, ‘h, k, l, m, and n’ can be natural numbers. ‘n’ can be greater than ‘l, m, and k’. Additionally, ‘n’ can be greater than ‘m+k+l’. ‘h’ can be 2 or more and 3 or less. The massage device 100 can accurately move the massage module 2170 to the corresponding area based on the massage area information included in the massage pattern.

The massage device 100 can perform a step 670 of providing a massage to the current user and outputting a guide signal for inducing the current user to breathe at a specific cycle. The guide signal can be output as sound or images. Additionally, the guide signal can be output as a recorded voice. In addition, the massage device 100 can automatically adjust the volume of the sound of the guide signal to guide the user's breathing. Moreover, the massage device 100 can automatically adjust the pitch of the sound to guide the user's breathing. Furthermore, the massage device 100 can modify the brightness of images on the display to guide the user's breathing.

The massage device 100 can relax the user's breathing by guiding the user's breathing at the specific cycle. That is, the massage device 100 can guide the user to reduce the breathing rate slowly and comfortably by extending the user's exhalation. The massage device 100 guides deep, slow and perfect breathing and makes the user be aware of the breathing to induce the user in a state of relaxation. Such breathing not only relaxes the user but also increases oxygen movement in the blood, thereby enhancing physical performance. Furthermore, the massage device 100 can maximize the effect of relaxation by providing a physical massage and inducing intra abdominal pressure (IAP) breathing. Through the above, the massage device 100 can decrease sympathetic nerve activity and relaxes muscles surrounding the small blood vessels, thereby helping to maintain reduced blood pressure. Through the respiratory relaxation, the massage device 100 according to an embodiment of the present disclosure can enhance the user's mobility and stability, strengthen the musculoskeletal system, improve neurological states such as heart rate variability and recovery, alleviate stress, relieve fatigue and tension, and strengthen the immune system.

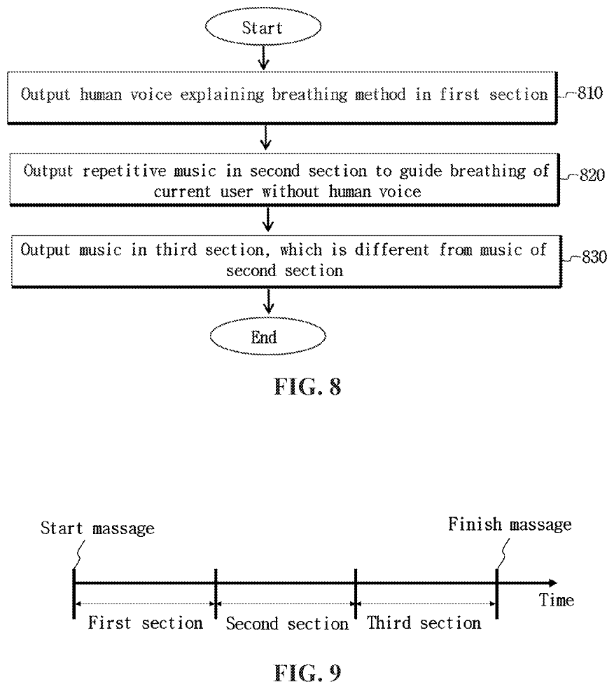

FIG. 8 is a flowchart illustrating the operation of the massage device according to an embodiment of the present disclosure. FIG. 9 is a view for depicting time intervals according to an embodiment of the present disclosure.

The step 670 of outputting the guide signal as illustrated in FIG. 6 may further perform the following steps. For instance, the massage device 100 can perform a step 810 of outputting a human voice explaining a breathing method to train the user to breathe in a first section, with phrases such as, “This program will gradually slow your breathing to less than six breaths per minute through the music cue”, “You will breathe in the method of exhaling slowly, comfortably, and long”, “First, let's train with ease”, “Breathe slowly to the music cue”, “Inhale and exhale, and inhale and exhale”, “Inhale through your nose and exhale through your mouth slowly”, and “Remember the musical tone for inhaling and the tone for exhaling”. In step 810, the massage device can additionally output repetitive music or repetitive light in a second section in addition to the human voice.

Referring to FIG. 9, the massage device 100 can sequentially perform the first, second, and third sections in the massage mode for managing blood pressure. That is, when the massage mode for managing blood pressure starts, the massage device 100 can perform the first section, and then, perform the second section, and finally, perform the third section.

The massage device 100 can perform a step 820 of outputting repetitive music for guiding the current user's breathing without the human voice in the second section. In the beginning of the second section, the human voice can inform the user of the transition to the second section. For example, the massage device 100 may output phrases, such as “Breathe comfortably to the music cue”, “Inhale, exhale, inhale, exhale”, “Close your eyes and breathe comfortably to the music cue”, or “If breathing is uncomfortable, don't force it”, or “Comfortable breathing is more important”, with the human voice. Subsequently, the massage device 100 can output repetitive music without human voice in the second section.

When performing the step 820 of outputting repetitive music, the massage device 100 can perform the following process. For instance, the massage device 100 can perform a step of repetitively changing the pitch of the sound from a first pitch to a second pitch for a first duration, and changing the pitch of the sound from the second pitch to the first pitch for a second duration (first output example). The pitch relates to the frequency of the sound. Additionally, the first pitch may be lower than the second pitch.

Here, the first duration can be shorter than the second duration, possibly 2 seconds or more and 5 seconds or less, such as around 4 seconds. The second duration can be 5 seconds or more and 7 seconds or less, for example, approximately 6 seconds. The massage device 100 can repeat the first output example for a period of 10 minutes or more and 20 minutes or less. That is, the second section can be 10 minutes or more and 20 minutes or less. More specifically, the second section can be 12 minutes or more and 15 minutes or less. In the second section, either the first or second duration can progressively increase. That is, the massage device can increase either the first or the second duration whenever the repetition is performed in the second section, thereby allowing the user to adapt to the new breathing method. The massage device 100 can induce the user to inhale for the first duration and exhale for the second duration, or vice versa.

The massage device 100 can perform a step of repetitively changing the volume of sound from a first volume to a second volume for the first duration, and changing from the second volume to the first volume for the second duration (second output example). Here, the first volume may be lower than the second volume, and the volume relates to the amplitude of the sound. As the first and second durations have been previously described, further repetition is omitted.

The massage device 100 can perform a step of repetitively changing the brightness of the display from a first brightness to a second brightness for the first duration, and changing from the second brightness to the first brightness for the second duration (third output example). The first brightness can be darker than the second brightness, or vice versa. As the first and second durations have been previously described, further repetition is omitted.

The massage device 100 can perform simultaneously at least one of the first output example, the second output example, and the third output example in the second section.

In the third section, the massage device 100 can perform a step 830 of outputting music different from the music of the second section. In the beginning of the third section, the human voice can inform the user of the transition to the third section. For example, the massage device 100 may output phrases, such as “Well done”, “If you followed the breathing to the end, you have successfully achieved a rate of six breaths per minute”, “But it's okay if you couldn't follow it till the end”, “Just spending a relaxing time is enough to have relaxed your body and mind”, or “Relax and feel the stabilized state of your body”, with the human voice. Subsequently, the massage device 100 can output repetitive music without human voice in the third section.

The music in the third section can have a lower volume or slower tempo than the music in the second section. Furthermore, the music in the third section may be non-repetitive, unlike the music in the second section.

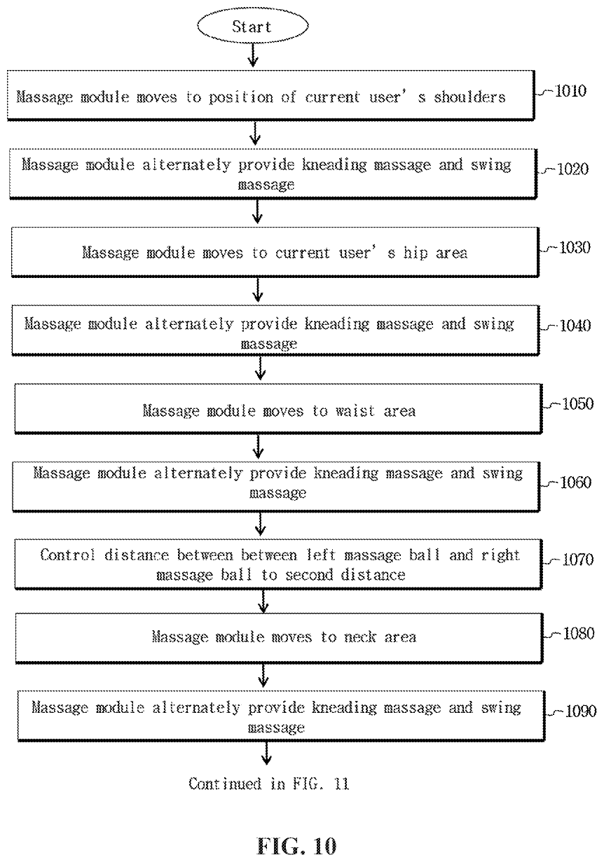

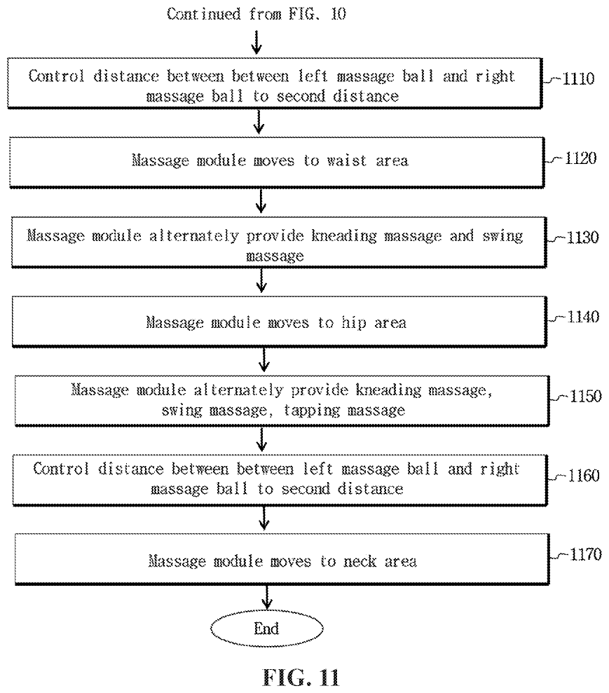

Till now, it has been described how the massage device 100 guides the user's breathing at a specific cycle. Hereinafter, the physical massage that the massage device 100 provides in the massage mode for managing blood pressure will be described. The massage device 100 can perform a step 660 of providing a massage to the current user. The step 660 can be performed simultaneously with the step 670 of outputting the guide signal for guiding breathing of the specific cycle. The steps 660 and 670 can be a step of providing the massage mode for managing blood pressure. Hereinafter, referring to FIGS. 10 and 11, massage patterns of the massage mode for managing blood pressure will be described.

FIG. 10 is a view illustrating the operation of the massage device 100 according to an embodiment of the present disclosure.

The massage device 100 can perform the following steps for the step 660 of providing a massage to the current user by using the massage module.

The massage device 100 can perform a step 1010 in which the massage module provides a kneading massage and moves to the position of the current user's shoulders. Kneading massage is a type of massage in which the massage balls of the massage module 2170 move in an elliptical pattern. The massage module 2170 can include kneading actuators, and the massage device 100 can control the actuators to make the massage balls move elliptically. The elliptical shape can form a predetermined angle with the ground. The predetermined angle can be −90 degrees or more and 90 degrees or less. When viewed from above the massage device 100, the left massage ball can move clockwise in an elliptical shape while the right massage ball can move counterclockwise. However, the present invention is not limited thereto, and when viewed from above the massage device 100, the massage device 100 can also make the left massage ball move counterclockwise in an elliptical shape and the right massage ball move clockwise.

As described above, the massage device 100 can perform the step 620 of determining the position of the user's shoulders by using the massage module, user input, or statistical methods. For instance, during the process of performing the step 620 of determining the position of the user's shoulders, the massage module 2170 can be lowered from the topmost position to the bottom. As described above, the massage device 100 can determine the position where the load on the massage module moving actuator increases as the position of the user's shoulders while moving the massage module 2170 downward. Here, ‘downward’ may mean from the head towards the hips when the user is sitting in the massage device 100. During the process of determining the position of the user's shoulders, the massage module 2170 may not be at the position of the user's shoulders. For instance, the massage module 2170 may be positioned in the middle of the hip area. The massage device 100 can use the massage module moving actuator in step 1010 to move the massage module 2170 from the middle of the hip area to the position of the user's shoulders.

As already described, the massage device 100 can determine the shoulder area. Moreover, the shoulder area can further be divided into h parts, wherein h can be two. That is, the shoulder area can include the upper and lower parts of the shoulder area. The massage device 100 can move the massage module 2170 to the shoulder area. More specifically, the massage device 100 can move the massage module 2170 to the upper part of the shoulder area.

The massage device 100 can provide the step 1010 for a fourth duration. The fourth duration can be longer than the third duration. The fourth duration can be 25 seconds or more and 35 seconds or less. For example, the fourth duration can be 30 seconds. It might take the massage device 100 the fourth duration to move the massage module 2170 from the middle of the hip area to the shoulder area.

The massage device 100 can perform a step 1020 in which the massage module alternately provides each of the kneading and swing massages at the position of the current user's shoulders for the third duration. The swing massage involves both left and right massage balls of the massage module 2170 moving either to the left or right side. For example, the left and right massage balls can be positioned eccentrically from a swing rotation axis. The swing rotation axis can extend forwards and backward. The left and right massage balls can move around the swing rotation axis to the left or the right.

The third duration can be a predetermined time. The third duration can be 7 seconds or more and 12 seconds or less, more specifically 10 seconds.

The cycle of the guide signal for guiding the current user to breathe at the specific cycle can also be the third duration. The sum of the first and second durations can be equal to the third duration. The cycle of the guide signal for guiding the specific cycle of breathing and the cycle of changing the massage type can be synchronized. The massage device 100 can change the massage type at the end of each cycle of inhalation and exhalation. For instance, the massage device 100 can repeat music every third duration. Moreover, the massage device 100 can change the massage type every third duration. The user can receive different massage types at the start of inhalation, or receive different massage types at the start of exhalation.

In the step 1020, the massage device 100 can provide kneading and swing massages twice each. The massage device 100 can massage the upper shoulder area as described above to stimulate the parasympathetic nervous system. When the parasympathetic nervous system is stimulated, blood circulation can be improved, so the massage device 100 can manage the user's blood pressure.

The step 660 of providing a massage to the current user by using the massage module 2170 can include the following process.

The massage device 100 can perform a step 1030 in which the massage module provides a swing massage and moves from the position of the current user's shoulders to the hip area. As described above, the massage device 100 can determine the hip area based on the position of the user's shoulders. The massage device 100 can move the massage module 2170 to the determined hip area. The massage device 100 can provide the step 1030 for the fourth duration.

As described above, the massage device 100 can determine the hip area, which can be further further be divided into h parts, wherein h can be three. That is, the hip area can include the upper, middle, and lower parts of the hip area. The massage device 100 can move the massage module 2170 to the hip area. More specifically, massage device 100 can move the massage module 2170 to the middle of the hip area.

The massage device 100 can perform a step 1040 in which the massage module 2170 alternately provides kneading and swing massages at the current user's hip area for the third duration for each. While there may be differences in the massage area, the description of step 1040 can be redundant with that of the step 1020, so the redundant description will be omitted.

The massage device 100 can provide kneading and swing massages twice for each in the step 1040. the massage device 100 can massage the middle of the hip area as described above to stimulate the parasympathetic nervous system. When the parasympathetic nervous system is stimulated, blood circulation can improve, thereby enabling the massage device 100 to manage the user's blood pressure.

The process of providing a massage to the current user by using the massage module 2170 in the step 660 can include the following process.

The massage device 100 can perform a step 1050 in which the massage module 2170 provides a kneading massage while moving from the current user's hip area to the waist area. As described above, the massage device 100 can determine the waist area based on the position of the user's shoulders. The massage device 100 can move the massage module 2170 to the determined waist area. The step 1050 can be provided for the third duration.

As described above, the massage device 100 can determine the waist area. Additionally, the waist area can be further divided into h parts, wherein h can be three. That is, the waist area can include the upper, middle, and lower parts of the waist area. The massage device 100 can move the massage module 2170 to the waist area. More specifically, massage device 100 can move the massage module 2170 to the lower part of the hip area.

The massage device 100 can perform a step 1060 in which the massage module alternately provides kneading and swing massages at the current user's waist area for the third duration for each. While there may be differences in the massage area, the description of step 1040 can be redundant with that of the step 1020, so the redundant description will be omitted.

The massage device 100 can provide kneading and swing massages twice for each in the step 1040. The massage device 100 can massage the lower part of the waist area as described above to stimulate the parasympathetic nervous system. When the parasympathetic nervous system is stimulated, blood circulation can improve, thereby enabling the massage device 100 to manage the user's blood pressure.

The massage device 100 can perform a step 1070 of controlling the distance between the left massage ball and the right massage ball in the massage module to a second distance. The second distance can be farther than the first distance. The distance between the left massage ball and the right massage ball can have a stages which are predetermined, wherein a can be 4 or more and 10 or less. The second distance can have four stages. When providing kneading and swing massages, the distance between the left massage ball and the right massage ball can vary. Additionally, after providing the kneading and swing massages, the distance between the left massage ball and the right massage ball can become disorganized. However, in a case in which the massage module 2170 moves up and down to provide a massage like acupressure, the distance between the left massage ball and the right massage ball may need to be set since the acupressure effect can vary depending on the distance.

The massage device 100 can perform a step 1080 in which the massage module 2170 provides acupressure massage while moving from the current user's waist area to the neck area. As described above, the massage device 100 can determine the user's neck area part based on the position of the current user's shoulders. In addition, the massage device 100 can pressurize the current user while moving the massage module 2170 from the waist to the neck area, thereby providing acupressure massage. In this instance, the distance between the left massage ball and the right massage ball can be the second distance.

The massage device 100 can provide the step 1080 for a fifth duration. The fifth duration can be longer than the third duration but shorter than the fourth duration. The fifth duration can be 15 seconds or more and 25 seconds or less. For example, the fifth duration can be 20 seconds.

The massage device 100 can perform a step 1090 in which the massage module 2170 alternately provides kneading and swing massages at the current user's neck area for the third duration for each. While there may be differences in the massage area, the description of step 1090 can be redundant with that of the step 1020, so the redundant description will be omitted.

The massage device 100 can massage the neck area as described above to stimulate acupoints. The acupoints may be Fengchi point and Baihui point. When Fengchi point or Baihui point is massaged, since the user's muscles are relaxed and energy and blood are invigorated, the massage device 100 can manage the user's blood pressure.

FIG. 11 is a view for depicting time intervals according to an embodiment of the present disclosure. to an embodiment of the present disclosure.

The massage device 100 can perform a step 1110 of controlling the distance between the left massage ball and the right massage ball in the massage module to a second distance. Additionally, the massage device 100 can perform a step 1120 in which the massage module 2170 provides acupressure massage while moving from the current user's neck area to the waist area. More specifically, the massage device 100 can move the massage module 2170 to the lower part of the waist area. The massage device 100 can provide step 1120 for the fifth duration.

The massage device 100 can perform a step 11130 in which the massage module 2170 alternately provides kneading and swing massages at the current user's waist area for the third duration for each. The step 1130 can be identical to the step 1060.

The massage device 100 can provide kneading and swing massages twice for each in the step 1040. As described above, the massage device 100 can massage the lower part of the waist area to stimulate the parasympathetic nervous system. When the parasympathetic nervous system is stimulated, blood circulation can improve, thereby enabling the massage device 100 to manage the user's blood pressure.

The massage device 100 can perform a step 1140 in which the massage module 2170 provides kneading massage while moving from the current user's waist area to the hip area. The step can be provided for the third duration.

Furthermore, the massage device 100 can perform a step 1150 in which the massage module 2170, at the user's hip area, provides at least one of kneading, swing, and tapping massages for more than the third duration for each. The massage device 100 can alternately provide kneading and swing massages for the third duration twice each. The device can also provide a composite massage for the third duration, wherein the composite massage may involve alternating or simultaneous kneading and tapping massages. In addition, the massage device 100 can provide swing massage for the third duration.

In the step 1040, the massage device 100 can provide kneading and swing massages twice each. As described above, the massage device 100 can massage the lower part of the waist area to stimulate the parasympathetic nervous system. When the parasympathetic nervous system is stimulated, blood circulation can improve, thereby enabling the massage device 100 to manage the user's blood pressure.

The massage device 100 can perform a step 1160 of controlling the distance between the left massage ball and the right massage ball in the massage module to a second distance. Additionally, the massage device 100 can perform a step 1170 in which the massage module 2170 provides acupressure massage while moving from the user's hip area to the neck area. The massage device 100 can provide step 1170 for the fifth duration.

The massage device 100 can repeat at least one of the steps from 1010 to 1090 and steps from 1110 to 1170.

The massage module 2170 may include a z-axis movement module. The z-axis movement module can be a module to move the massage module 2170 forwards or backward. ‘forwards and backward’ may mean the user's forward direction and backward direction when the user sits in the massage device 100. When the massage module 2170 moves forward, since the massage balls are closer to the user, the user is provided with stronger stimulation. When the massage module 2170 moves backward, since the balls are farther from the user, the user is provided with weaker stimulation. The massage device 100 can move the massage module 2170 to the farthest back by using the z-axis movement module to provide the steps from 1010 to 1090 and steps from 1110 to 1170. That is, the massage device 100 makes the massage module 2170 provide gentle stimulation to the user, thereby aiding in breathing and relaxation without disturbance.

The massage device 100 can provide a massage mode for managing blood pressure by using either the user-set massage intensity or a default intensity setting. The massage intensity can be determined by the speed or travel distance of the massage balls included in the massage module. The greater speed or travel distance of the massage balls is, the higher massage intensity is. In addition, The smaller speed or travel distance of the massage balls is, the lower massage intensity is.

The massage device 100 can determine the vertical movement speed of the massage module 2170 by using either the user-set value or the default value. A faster vertical movement speed of the module will provide a stronger stimulation to the user, while a slower speed will provide a weaker stimulation.

As described above, the massage modes for managing blood pressure have been described. Hereinafter, a method for automatically managing the user's blood pressure by collecting information related to the current user's blood pressure will be described. The massage device according to the present disclosure proposes a comprehensive solution for blood pressure management without requiring the user's constant attention.

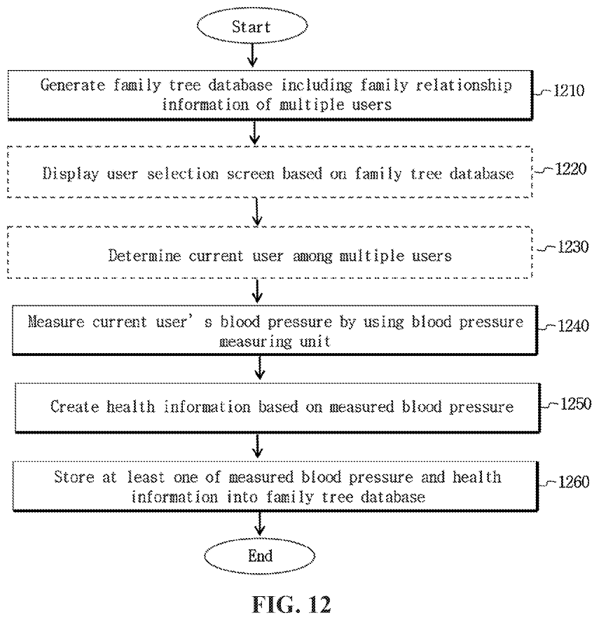

FIG. 12 illustrates the operation of the massage device according to an embodiment of the present disclosure.

As described above, the massage device 100 can include a blood pressure measuring unit. The massage device 100 can perform a step 1210 of creating a family tree database containing family relationship information of a plurality of users. The massage device 100 can create the family tree database during the process of setting the massage device 100 by a user who purchased the massage device 100. The family tree database can be stored in the memory of the device 100 or transmitted to an external service server. The family tree database can include information on whether there is a hypertension patient among lineal ascendants or lineal descendants of the current user.

Moreover, the family tree database can accumulate and store each individual user's blood pressure data. The massage device 100 can periodically track and observe the progression or improvement of hypertension based on changes in the individual user's blood pressure cumulatively stored. Therefore, the massage device 100 can comprehensively manage the hypertension conditions of the family.

To perform the step 1210 of creating a family tree database, the massage device 1000 can further perform the following process. The massage device 100 can perform a step of receiving at least one of identification information, age-related information, and gender information from the plurality of users. The massage device 100 can store at least one of identification information, age-related information, and gender information in the family tree database. The identification information can include names, IDs, phone numbers, or email addresses. The age-related information can include the user's age or date of birth. Additionally, the massage device 100 can further receive and store users' height or weight in the family tree database. The massage device 100 can create a user account and store the age-related information, gender, height, or weight in the corresponding account based on the identification information of the user.

The massage device 100 can perform a step of automatically creating family relationship information for the plurality of users based on the age-related information and gender information of the users. However, the present invention is not limited thereto, and the massage device 100 can create the family relationship information of the plurality of users based on user input.

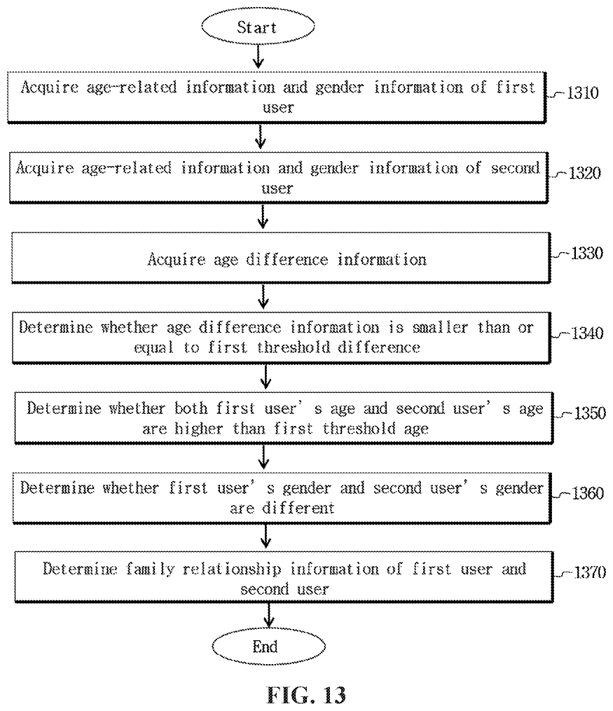

Hereinafter, referring to FIG. 13, the process of automatically creating the family relationship information by the massage device 100 according to an embodiment of the present invention will be described.

FIG. 13 is a flowchart illustrating an operating method of the massage device according to an embodiment of the present disclosure.

The massage device 100 can perform a step 1310 of acquiring age-related information and gender information of a first user. As described above, the age-related information may include the user's actual age or date of birth. The massage device 100 can perform a step 1320 of acquiring age-related information and gender information of a second user. The first user may have entered the user-related information into the massage device 100 before the second user. Furthermore, t massage device 100 can perform a step 1330 of obtaining an absolute value of the difference between the age-related information of the first user and the age-related information of the second user as first age difference information.

The massage device 100 can perform a step 1340 of determining whether the first age difference information is less than or equal to a first threshold difference. The first threshold difference is a predetermined value, and may be 12 years. The massage device 100 can perform a step 1350 of determining whether both the first and second users' ages are greater than a first threshold age. The first threshold age is a predetermined value, and may be a number representing adulthood. For instance, the first threshold age may be 19 years old. The massage device 100 can perform a step 1360 of determining whether the genders of the first and second users are different. Additionally, the massage device 100 can perform a step 1370 of determining the family relationship information of the first user and the second user.

When the first age difference information is less than or equal to the first threshold difference, and both the age of the first user and the age of the second user are greater than the first threshold age, and the genders of the first and second users are different, the massage device 100 can set the family relationship information of one of the first user and the second user as a husband, and the other as a wife. More specifically, the massage device 100 can set the family relationship information of one of the first user and the second user as a husband, and the other as a wife depending on their genders. For example, if the first user's gender is male, the first user could be set as a husband.

The massage device 100 can perform a step of acquiring age-related and gender information of a third user. The massage device 100 can obtain an absolute value of the difference between the age-related information of the first user and the age-related information of the third user as second age difference information. The massage device 100 can obtain an absolute value of the difference between the age-related information of the second user and the age-related information of the third user as third age difference information. If either the second or third age difference information is greater than the first threshold age, and the third user's age-related information indicates that the third user is younger than the first or second user, the massage device 100 can determine the third user's family relationship information as a lineal descendant of either the first user or the second user. Additionally, if either the second or third age difference information is greater than the first threshold age, and the third user's age-related information indicates that the third user is older than the first or second user, the massage device 100 can determine the third user's family relationship information as a lineal ascendant of either the first user or the second user.

Referring back to FIG. 12, the steps 1220 and 1230 may be optional. The massage device 100 can perform a step 1240 without carrying out the steps 1220 and 1230, but the present disclosure is not limited thereto.

The massage device 100 can perform a step 1220 of displaying a user selection screen based on the family tree database. The massage device 100 can display the identification information of the user stored in the family tree database on the screen. The massage device 100 can display the screen on the display of the massage device. However, the present invention is not limited thereto, and the massage device 100 can transmit control signals wirelessly or wired to an external device, so that the external device can display the identification information of the user stored in the family tree database.

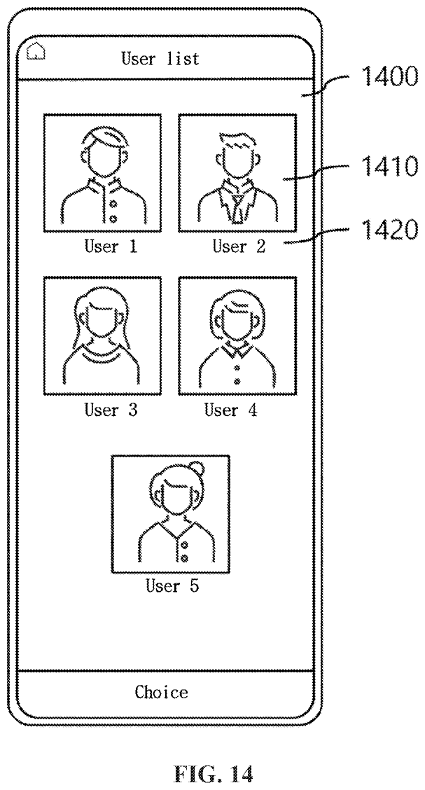

For example, the user selection screen can be as illustrated in FIG. 14.

FIG. 14 is a view depicting a screen for selecting a user according to an embodiment of the present disclosure.

FIG. 14 represents a screen 1400 displayed on the display of the massage device 100 or on a display of an external device.

The massage device 100 can display the user's image on a first area 1410 of the screen 1400. The user's image may be one selected by the user or input by the user. The user's image can be included in the user identification information. The massage device 100 can display the user's name, ID, position, family relationship information, phone number, or email address on a second area 1420 of the screen 1400. The user can check the first area 1410 or the second area 1420 and select the user's account.

Referring back to FIG. 12, the massage device 100 can perform a step 1230 of determining the current user among the plurality of users. Moreover, the current user could mean the user currently using the massage service. Alternatively, the current user could mean the user currently sitting on the massage device. For example, the massage device 100 can perform a step 1230 of determining the current user among the plurality of users based on user input. However, the present disclosure is not limited thereto, and the massage device 100 can determine the current user based on user information. Here, the user information may include at least one of the measured blood pressure or measured shoulder height.

The massage device 100 can perform a step 1240 of measuring the current user's blood pressure by using the blood pressure measuring unit. The massage device 100 can receive input indicating the execution of a massage mode for blood pressure management from the user in the step 610. After the step 610, the massage device 100 can perform the step 640 or 1240 of measuring the current user's blood pressure. The steps 620 and 630 can be further performed before the step 640 or 1240, but the present disclosure is not limited thereto.

The massage device 100 can receive information indicating whether the current user is hypertensive from the family tree database. If the current user is indicated as hypertensive, the massage device 100 can perform the step 1240 of measuring the user's blood pressure before providing a massage. In other words, regardless of whether the user has selected a massage mode for managing blood pressure, the massage device 100 can measure the user's blood pressure. Furthermore, if there is a hypertensive person among the current user's lineal ascendants, the massage device 100 can perform the step 640 or 1240 of measuring the user's blood pressure before providing a massage. In addition, the massage device 100 can measure blood pressure at predetermined intervals regardless of the user's blood pressure and family history. For example, the massage device 100 can measure the user's blood pressure every 3 hours, 6 hours, 12 hours, or once a day.

As described above, the steps 1220 and 1230 are optional, and may not be performed. If the steps 1220 and 1230 are not performed, the massage device 100 may not know whose blood pressure has been measured in the step 1240 within the family tree database. Therefore, the massage device 100 can perform a process to determine who the current user is within the family tree database. That is, when the steps 1220 and 1230 are not performed, the massage device 100 can perform the following process after the step 1240 to determine the current user.

The massage device 100 can determine the current user by using user information acquired through the massage device 100. The user information acquired through the massage device 100 can include body scan information such as the measured shoulder position or leg length. Moreover, the information acquired through the massage device 100 can include at least one of biometric information like an electrocardiogram, measured blood pressure, or brain waves. The massage device 100 can determine the current user based on at least one of the body scan information or the biometric information.

As described above, the massage device 100 can determine the acquired height of the current user's shoulders. The massage device 100 can acquire heights of the plurality of users' shoulders from the family tree database. The massage device 100 can obtain a shoulder height which is the most similar to the acquired height of the current user's shoulders among the heights of the plurality of users' shoulders. The massage device 100 can determine the user corresponding to the similar shoulder height among the plurality of users in the family tree database as the current user.

The massage device 100 can determine a length of the current user's leg based on the extended length of the leg massage unit. The massage device 100 can acquire the lengths of multiple users' legs from the family tree database. The massage device 100 can obtain a leg length which is the most similar to the acquired length of the current user's leg among the lengths of multiple users' legs. The massage device 100 can determine the user corresponding to the similar leg length among the plurality of users in the family tree database as the current user.

After performing the step 1240 of measuring the current user's blood pressure by using the blood pressure measuring unit, the massage device 100 can further perform the following process. The massage device 100 can perform a step of acquiring the existing blood pressure records of the plurality of users from the family tree database. The database may store past measured blood pressure records for each of the plurality of users. The massage device 100 can acquire the existing blood pressure records based on the past measurements. The massage device 100 can acquire a predetermined number of blood pressure records from the most recent to the past for each user from the family tree database. The predetermined number can be one or more and 15 or less. The massage device 100 can acquire the existing blood pressure by weighted averaging the predetermined numbers of past blood pressure records. The weighted average can be as follows:

Existing Blood Pressure=w1*b1+w2*b2+ . . . +wm*bm,

wherein, ‘w1’ to ‘wm’ can be weighted values. ‘m’ can be the predetermined number. ‘b1’ can be the most recent measured blood pressure of one user, and ‘bm’ can be the oldest measured blood pressure. The sum of ‘w1’ to ‘wm’ can be 1. The values can decrease from w1 to wm, but the present invention is not limited thereto, and ‘w1’ to ‘wm’ may have the same value.

The massage device 100 can perform a step of determining a similar blood pressure that is the closest to the measured current user's blood pressure among the existing blood pressure records. Here, the measured current user's blood pressure may mean the blood pressure measured in the step 1240. The massage device 100 can obtain the absolute value of the difference between the existing blood pressures of the plurality of users and the measured current user's blood pressure. Furthermore, the massage device 100 can select the existing blood pressure with the smallest absolute difference. The massage device 100 can determine the selected existing blood pressure as the similar blood pressure.

The massage device 100 can perform a step of determining the user, who corresponds to the similar blood pressure, among the plurality of users included in the family tree database, as the current user. Before determining the user corresponding to the similar blood pressure as the current user, the massage device 100 can output a confirmation message to the user. The massage device 100 can determine the user corresponding to the similar blood pressure as the current user based on the user's confirmation input. Although only blood pressure as the biometric information has been described, the same process can be applied to other biometric information, such as electrocardiograms, brain waves, and weight. Therefore, redundant descriptions will be omitted.

Furthermore, although the current user is determined based on the comparison of scalar values as described above, the massage device 100 can also determine the current user by using vectors. The massage device 100 can acquire a current user vector by using at least one of the body scan information or the biometric information. The current user vector may include multiple dimensions. The multiple dimensions can include at least one of shoulder position, leg length, electrocardiogram, brain wave, or weight. The massage device 100 can acquire user vectors for each of the multiple users from the family tree database. The massage device 100 can obtain a similar vector that is the most similar to the current user vector among the user vectors. In addition, the massage device 100 can determine the user corresponding to the similar vector, among the plurality of users included in the family tree database, as the current user.

Referring to FIG. 12, the massage device 100 can perform a step 1250 of generating health information based on the measured blood pressure. Additionally, the massage device 100 can perform a step 1260 of storing at least one of the measured blood pressure and the health information in the family tree database. The health information can be information helpful for improving the user's blood pressure. The massage device 100 may store a health information table correlating the health information according to the blood pressure. The massage device 100 can select health information from the health information table based on the measured blood pressure of the current user. In addition, the massage device 100 can cumulatively store the selected health information and the measured blood pressure of the current user in the family tree database.

Furthermore, the massage device 100 can display the measured blood pressure and the selected health information on the display of the massage device or on the display of the external device.

The massage device 100 can determine whether the current user is hypertensive or not based on the current user's blood pressure. More specifically, the massage device 100 can further perform the following process in the step 1240 of measuring the current user's blood pressure by using the blood pressure measuring unit.

The massage device 100 can perform a step of acquiring a plurality of past blood pressure records of the current user during a predetermined period based on the family tree database. If the current user has previously measured the blood pressure using the massage device 100, at least one past blood pressure may be stored in the family tree database. The predetermined period can be a week, 10 days, or a month. The massage device 100 can perform a step of acquiring the plurality of past blood pressure records of the current user during the predetermined period from on the family tree database.

The massage device 100 can perform a step of acquiring a representative blood pressure of the current user based on the multiple past blood pressure records and the measured blood pressure. More specifically, the massage device 100 can determine whether the number of past and measured blood pressures is equal to or exceeds a predetermined number of threshold blood pressures. The predetermined number of threshold blood pressures, for example, could be 10. If the number of past and measured blood pressures is equal to or greater than the predetermined number of threshold blood pressures, the massage device 100 can perform a step of acquiring a representative blood pressure. However, if the number of past and measured blood pressures is less than the predetermined number of threshold blood pressures, the massage device 100 may not acquire a representative blood pressure.

However, the present disclosure is not limited thereto, and the massage device 100 can perform a step of acquiring the representative blood pressure if the past blood pressures and the measured blood pressure have been taken daily during a predetermined threshold period. If the past blood pressures and the measured blood pressure have not been measured daily during the predetermined threshold period, the massage device 100 may not acquire a representative blood pressure.

The representative blood pressure could be the average or median value of the multiple past blood pressures and the measured blood pressure. As described above, the massage device 100 can increase the reliability of the representative blood pressure by acquiring the representative blood pressure when the number of the multiple blood pressures and the measured blood pressure exceeds the predetermined threshold blood pressure. When the representative blood pressure is obtained, the following steps can be performed.

The massage device 100 can perform the following process to perform the step 1250 of generating the health information based on the measured blood pressure.

When the representative blood pressure is 135/85 mmHg or above but less than 160/100 mmHg, the massage device 100 can perform a step of determining hypertension information of the current user as Stage I hypertension. Moreover, the massage device 100 can select the health information corresponding to Stage I hypertension from the health information table. The massage device 100 can display the health information on the display of the massage device or on the display of the external device. In addition, the massage device 100 can store at least one of the determined hypertension information and the health information in the family tree database.

When the representative blood pressure is 160/100 mmHg or more, the massage device 100 can perform a step of determining the hypertension information of the current user as Stage II hypertension. Moreover, the massage device 100 can select the health information corresponding to Stage II hypertension from the health information table. The massage device 100 can display the health information on the display of the massage device or on the display of the external device. In addition, the massage device 100 can store at least one of the determined hypertension information and the health information in the family tree database.

When the representative blood pressure is 130/100 mmHg or above but less than 135/85 mmHg, the massage device 100 can perform a step of determining the hypertension information of the current user as a mild hypertension. Moreover, the massage device 100 can select the health information corresponding to the mild hypertension from the health information table. The massage device 100 can display the health information on the display of the massage device or on the display of the external device. In addition, the massage device 100 can store at least one of the determined hypertension information and the health information in the family tree database.

In addition, when the representative blood pressure is less than 130/100 mmHg, the massage device 100 can perform a step of determining the hypertension information of the current user as a normal state. Moreover, the massage device 100 can store the hypertension information in the family tree database.

To perform the step 1250 of generating the health information based on the measured blood pressure, the massage device 100 can perform the following process.

The massage device 100 can perform a step of determining whether the hypertension information of the maternal lineal ascendant of the current user includes Stage I hypertension or Stage II hypertension, based on the family tree database.

The massage device 100 can perform a step of determining whether the hypertension information of the paternal lineal ascendant of the current user includes Stage I hypertension or Stage II hypertension, based on the family tree database.

When the hypertension information of the maternal or paternal lineal ascendant of the current user includes Stage I hypertension or Stage II hypertension, the massage device 100 can determine the hypertension family history information of the current user as ‘dangerous’. Additionally, the massage device 100 can select health information corresponding to the ‘dangerous’, when the hypertension family history information is ‘dangerous’, from the health information table. The massage device 100 can display the health information on the display of the massage device or the display of the external device.

When one among the hypertension information of the maternal lineal ascendant of the current user and the hypertension information of the paternal lineal ascendant of the current user includes Stage I hypertension or Stage II hypertension, the massage device 100 can determine the hypertension family history information as ‘moderate’. The massage device 100 can select health information corresponding to the ‘moderate’, when the hypertension family history information is ‘moderate’, from the health information table. The massage device 100 can display the health information on the display of the massage device or the display of the external device.

When one among the hypertension information of the maternal lineal ascendant of the current user and the hypertension information of the paternal lineal ascendant of the current user does not include Stage I hypertension or Stage II hypertension, the massage device 100 can determine the hypertension family history information as ‘none’.

The massage device 100 can store the hypertension family history information in the family tree database.

When performing the step 1250 of generating health information based on the measured blood pressure, the massage device 100 can further perform the following process.

The massage device 100 can perform a step of selecting health information corresponding to at least one of the hypertension family history information and the hypertension information, among pre-stored multiple health information. The massage device 100 can store a health information table in which the health information corresponds to the at least one of the hypertension family history information and the hypertension information. The massage device 100 can perform a step of selecting health information corresponding to the at least one of the hypertension family history information and the hypertension information from the health information table. The massage device 100 can perform a step of displaying the selected health information on the display.

The massage device 100 can perform a step of providing a massage corresponding to the at least one of the hypertension family history information and the hypertension information. When the hypertension family history is ‘dangerous’ or ‘moderate’, or the hypertension information indicates Stage I hypertension, Stage II hypertension, or mild hypertension, the massage device 100 can perform a massage mode for managing blood pressure. More specifically, the hypertension family history is ‘dangerous’ or ‘moderate’, or the hypertension information indicates Stage I hypertension, Stage II hypertension, or mild hypertension, the massage device 100 can propose the massage mode for managing blood pressure to the user. The massage device 100 can provide a massage mode for managing blood pressure to the user based on the user's input in selecting the massage mode for managing blood pressure. The process of providing the massage mode for managing blood pressure to the user can include the steps 620 to 670.

The massage device 100 can further perform the following process in order to perform the step 1240 of measuring the current user's blood pressure by using the blood pressure measuring unit.

The massage device 100 can include a step of acquiring at least one of information on alcohol consumption, information on smoking status, and information on blood pressure medication of the current user. The user can input at least one of information on alcohol consumption, information on smoking status, and information on blood pressure medication of the current user into the massage device 100 by using an input unit of the massage device 100 or an external device.

The massage device 100 can further perform the following process in order to perform the step 1250 of generating the health information based on the measured blood pressure. The massage device 100 can perform a step of selecting health information corresponding to the at least one of the information on alcohol consumption, the information on smoking status, the information on blood pressure medication, the hypertension family history information, and the hypertension information of the user, among the pre-stored multiple health information. Additionally, the massage device 100 can perform a step of providing a massage corresponding to the at least one of the information on alcohol consumption, the information on smoking status, the information on blood pressure medication, the hypertension family history information, and the hypertension information of the user. The massage corresponding to the at least one of the information on alcohol consumption, the information on smoking status, the information on blood pressure medication, the hypertension family history information, and the hypertension information of the user can include the massage mode for managing blood pressure. However, the present invention is not limited thereto, and the massage can include alcohol cessation meditation massage, smoking cessation meditation massage, soothing hand massage, and immunity massage.

The massage device 100 can score the information on alcohol consumption, the information on smoking status, the information on blood pressure medication, and the hypertension family history information. For example, if the current user frequently consumes alcohol, the massage device 100 can add 15 points to a lifestyle improvement indicator of the current user, or if not so, the massage device can add 0 points. Moreover, if the user smokes frequently, the massage device 100 can add 15 points to the lifestyle improvement indicator of the current user, or if not so, the massage device can add 0 points. Additionally, if the current user takes antihypertensive drug, the massage device 100 can add 30 points to the lifestyle improvement indicator of the current user, or if not so, the massage device can add 0 points. In addition, if the information on hypertension family history is ‘dangerous’, the massage device can add 40 points to the lifestyle improvement indicator, if ‘moderate’, add 30 points, and if ‘none’, add 0 points. The massage device 100 can offer various massages and additional services according to the scores. The massage device 100 can assist the user in quickly improving the lifestyle habits, starting with easy or desired changes, by offering various massages and additional services.

The massage device 100 can classify the current user into 24 types based on the information on alcohol consumption, the information on smoking status, the information on blood pressure medication, and the hypertension family history information of the user. If the user consumes alcohol, the device 100 can suggest at least one of a alcohol cessation meditation massage mode or an alcohol treatment. If the user smokes, the massage device 100 can suggest at least one of a smoking cessation meditation massage mode or a smoking cessation treatment. If the user takes antihypertensive drug, massage device 100 can suggest at least one of a soothing hand massage mode or a medication reminder service. In addition, if the user's hypertension family history is ‘dangerous’, the massage device 100 can suggest at least one of a first immunity massage mode or a genetic test. if the user's hypertension family history is ‘moderate’, the massage device 100 can suggest at least one of a second immunity massage mode or a genetic test. The first immunity massage mode and the second immunity massage mode can differ from each other. The second immunity massage mode can be a simplified version of the first immunity massage mode.

If the user does not drink alcohol, smoke, take antihypertensive drug, and has ‘none’ in hypertension family history, the massage device 100 can offer a general massage mode. For instance, the general massage mode can include at least one of a concentration mode, a meditation mode, a recovery mode, a stretching mode, a sleep mode, a vitality mode, a golf mode, a hip-up mode, a student mode, a zero-gravity mode, and a growth mode.

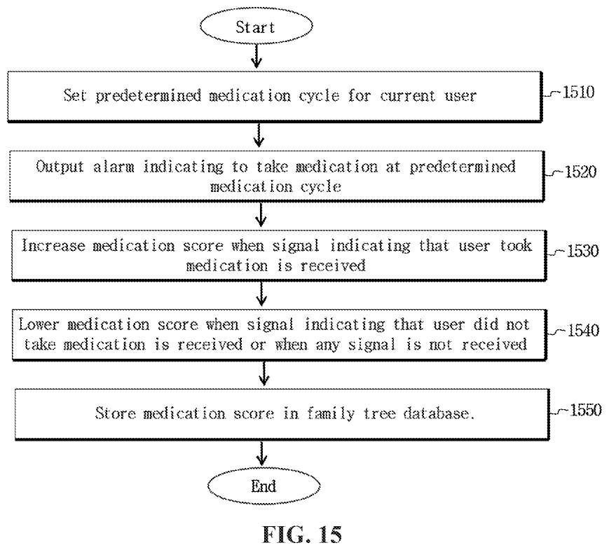

FIG. 15 is a flowchart illustrating an operating method of the massage device 100 according to an embodiment of the present disclosure.

FIG. 15 illustrates a process in which the massage device 100 provides the medication reminder service. When the current user's information on blood pressure medication indicates ongoing blood pressure medication, the massage device 100 can perform a step 1510 of setting a predetermined medication cycle. The massage device 100 can acquire the identification information of the medication being taken by the user. Based on the identification information of the medication being taken by the user, the massage device 100 can acquire the predetermined medication cycle. The massage device 100 can store a medication cycle table in which the medication cycle corresponds to the identification information of the medication. Here, the identification information of the medication can include the shape, form, or name of medication. The massage device 100 can automatically set the predetermined medication cycle based on the medication cycle table.

However, the present disclosure is not limited thereto, and the massage device 100 can set the predetermined medication cycle. For instance, the predetermined medication cycle can be once a day in the morning. More specifically, the predetermined medication cycle can be between 5 AM and 12 PM. Alternatively, the predetermined medication cycle can be twice a day, namely, before 6 AM and 6 PM daily. For example, more specifically, the predetermined medication cycle can be between 5 AM to 12 o'clock in the morning, and between 12 o'clock to 6 PM in the afternoon.

However, the present disclosure is not limited thereto, and the massage device 100 can change the predetermined medication cycle based on the user's input.

The massage device 100 can perform a step 1520 of outputting an alarm to inform medication time to take medication at the predetermined medication cycle. The massage device 100 can output the alarm through an output unit 340 included in the massage device 100. However, the present disclosure is not limited thereto, and the massage device 100 can transmit a signal for outputting the alarm to an external device wirelessly or by wire. When receiving the signal from the massage device 100, the external device can output the alarm.

The massage device 100 can output the alarm regardless of the predetermined medication cycle. The massage device 100 can determine a predetermined medication time based on sensors of an external device. For instance, the external device can be a smartwatch or a smartphone. The smartwatch can generate a signal indicating whether the user has woken up based on the sensors. The smartwatch can measure the user's biometric signals to generate a signal indicating whether the user has woken up. Moreover, the smartwatch can detect the wearing of the watch in the morning to generate a signal indicating whether the user has woken up. Additionally, the smartphone can detect the user's action of picking up the phone in the morning by using an accelerometer or a gyro sensor to generate a signal indicating whether the user has woken up. When receiving the signal indicating whether the user has woken up from the smartwatch, the massage device 100 can perform the step 1520 of outputting an alarm for medication.

When the massage device 100 receives a signal, which indicates that the current user has taken medication, from the current user, the massage device 100 can perform a step 1530 of increasing the medication score. More specifically, when receiving the signal, which indicates that the current user has taken medication, from the current user within a predetermined time after the alarm is output, the massage device 100 can perform the step 1530 of increasing the medication score.

When the massage device 100 receives a signal, which indicates that the current user did not take medication, from the current user, or does not receive any information, the massage device 100 can perform a step 1540 of lowering the medication score.

The massage device 100 can perform a step 1550 of storing the medication score in the family tree database. The massage device 100 can select and provide health information to the user based on the medication information.

When the hypertension information is one of Stage I hypertension, Stage II hypertension, and mild hypertension, the massage device 100 can perform a step of displaying a message inquiring if the user took a predetermined first rest period before measuring blood pressure in the step 1240. The predetermined first rest period can be between 5 to 15 minutes, for example, 10 minutes.

When receiving a signal indicating that the user did not take the first rest period, the massage device 100 can perform a step of re-measuring the current user's blood pressure after a predetermined second rest period. The second rest period may range from 3 to 7 minutes, for example, 5 minutes. The massage device 100 can obtain the difference between the newly measured blood pressure and the previously measured blood pressure. If the absolute value of the difference is below a predetermined threshold, the massage device 100 can determine the average of the newly measured blood pressure and the previously measured blood pressure as the current blood pressure. If the absolute value exceeds the predetermined threshold, the newly measured blood pressure is determined as the current blood pressure, and the previously measured blood pressure can be discarded. The massage device 100 can store the current blood pressure in the family tree database in the step 1260.

When receiving a signal indicating that the user took the first rest period, the massage device 100 can perform a step of displaying a message inquiring if the user had coffee, smoked, consumed alcohol, or exercised within a predetermined third rest period before measuring blood pressure.

When a signal indicating that the user has consumed coffee, smoked, drunk alcohol, or exercised within the third rest period is received from the current user, the massage device 100 can perform a step of deciding the hypertension information as one of Stage I hypertension, Stage II hypertension, and mild hypertension. When a signal indicating that the user did not consume coffee, smoked, drunk alcohol, or exercised within the third rest period is received from the current user, the massage device 100 may perform a step of remeasuring the blood pressure of the current user after the third rest period. The third rest period may be no less than 25 minutes and no more than 35 minutes. For example, the third rest period may be 30 minutes. The massage device 100 can display a message, which suggests a massage mode for lowering hypertension, on the display. According to the user's choice, the massage device 100 can provide a massage to the user based on the massage mode. After the massage is completed, the massage device 100 can remeasure the user's blood pressure. When the absolute value of the differential blood pressure is below a predefined threshold differential blood pressure, the massage device 100 can determine the current blood pressure as the average of the remeasured blood pressure and the previously measured blood pressure. Additionally, when the absolute value of the differential blood pressure exceeds the predefined threshold differential blood pressure, the massage device 100 can determine the current blood pressure as the remeasured blood pressure. The previously measured blood pressure can be discarded. In the step 1260, the massage device 100 can store the current blood pressure in the pedigree database.

Various embodiments have been examined so far. Those skilled in the art in the field to which this invention pertains will understand that this invention can be implemented in a modified form without departing from the essential characteristics of the invention. Therefore, the disclosed embodiments should be considered in a descriptive sense and not as a limiting perspective. The scope of the invention is not indicated by the aforementioned description, but by the claims, and all differences within the equivalent scope should be construed as being included in the invention.

Meanwhile, the embodiments of the present disclosure described above can be written as a program executable on a computer, and implemented on a general-purpose digital computer that operates the program using a computer-readable recording medium. The computer-readable recording medium includes storage media such as magnetic storage media (for example, ROM, floppy disk, hard disk, etc.) and optical reading media (for example, CD-ROM, DVD, etc.).

1. method of operating a massage device, comprising:
a step of receiving an input from a current user to execute a massage mode for managing blood pressure;
a step of determining the position of the current user's shoulders;
a step of controlling a distance between a left massage ball and a right massage ball included in a massage module to a first distance;
a step of providing a massage to the current user by using the massage module; and
a step of outputting a guide signal to induce the current user to breathe in a specific cycle while providing the massage to the current user.

2. The method of operating a massage device according to claim 1, wherein the step of outputting the guide signal comprises the steps of:
a step of outputting a human voice explaining a breathing method in a first section to train the user to breathe;
a step of outputting repetitive music in a second section to guide the breathing of the current user without the human voice; and
a step of outputting music in the third section, which is different from the music of the second section.

3. The method of operating a massage device according to claim 2, wherein the step of outputting repetitive music comprises at least one of the steps of:
repeatedly changing the pitch of the sound from a first pitch to a second pitch for a first duration, and from the second pitch to the first pitch for a second duration;
repeatedly changing the volume of the sound from a first volume to a second volume for the first duration, and from the second volume to the first volume for the second duration; and
repeatedly changing the brightness of a display from a first brightness to a second brightness for the first duration, and from the second brightness to the first brightness for the second duration,
wherein the first pitch is lower than the second pitch,
wherein the first volume is lower than the second volume,
wherein the first brightness is darker than the second brightness, and
wherein the first duration is shorter than the second duration.

4. The method of operating a massage device according to claim 3, wherein at least one of the first duration and the second duration in the second section is gradually lengthened.

5. The method of operating a massage device according to claim 1, wherein the step of providing a massage to the current user by using the massage module comprises:
a step in which the massage module moves to the position of the current user's shoulders while providing a kneading massage; and
a step in which the massage module alternately provides a kneading massage and a swing massage at the position of the current user's shoulders for a third duration for each.

6. The method of operating a massage device according to claim 5, wherein the step of providing a massage to the current user by using the massage module comprises:
a step in which the massage module moves form the position of the current user's shoulders to the current user's hip area while providing a swing massage; and
a step in which the massage module alternately provides a kneading massage and a swing massage at the current user's hip area for the third duration for each.

7. The method of operating a massage device according to claim 6, wherein the step of providing a massage to the current user by using the massage module comprises:
a step in which the massage module moves form the current user's hip area to the current user's waist area while providing a kneading massage; and
a step in which the massage module alternately provides a kneading massage and a swing massage at the current user's waist area for the third duration for each.

8. The method of operating a massage device according to claim 7, further comprising:
a step of controlling a distance between the left massage ball and the right massage ball included in the massage module to a second distance;
a step in which the massage module moves form the current user's waist area to the current user's neck area while providing an acupressure massage; and
a step in which the massage module alternately provides a kneading massage and a swing massage at the current user's neck area for the third duration for each.

9. The method of operating a massage device according to claim 8, further comprising:
a step of controlling a distance between the left massage ball and the right massage ball included in the massage module to a second distance;
a step in which the massage module moves form the current user's neck area to the current user's waist area while providing an acupressure massage; and
a step in which the massage module alternately provides a kneading massage and a swing massage at the current user's waist area for the third duration for each.

10. The method of operating a massage device according to claim 9, wherein the step of providing a massage to the current user by using the massage module comprises:
a step in which the massage module moves form the current user's waist area to the current user's hip area while providing a kneading massage;
a step in which the massage module provides at least one of a kneading massage, a swing massage, and a tapping massage at the current user's hip area for the third duration or more;
a step of controlling a distance between the left massage ball and the right massage ball included in the massage module to a second distance; and
a step in which the massage module moves form the current user's hip area to the current user's neck area while providing an acupressure massage.
